(19) United States
(12) Patent Application Publication
(10) Pub. No.: US 2026/0226375 A1
(43) Pub. Date: Aug. 6, 2026

(54) RINSE AID COMPOSITION COMPRISING A STRUCTURAL POLYPEPTIDE

(71) Applicant: AMSILK GMBH, Neuried (DE)

(72) Inventors: Andreas SCHMIDEDER, Velden (DE); Mauro DAVANZO, Ludwigshafen am Rhein (DE)

(21) Appl. No.: 19/152,908

(22) PCT Filed: Feb. 1, 2024
(86) PCT No.: PCT/EP2024/052456

§ 371 Date: Jul. 31, 2025

(30) Foreign Application Priority Data
Feb. 2, 2023 (EP) 23154767.0

(51) Int. Cl. C11D 3/384; C11D 1/72; C11D 3/20; C11D 3/37

(52) U.S. Cl. CPC C11D 3/384; C11D 1/72; C11D 3/2086; C11D 3/378; C11D 2111/14

(57) ABSTRACT

The present invention relates to a rinse aid composition for dishwashers comprising a structural polypeptide, a method for machine cleaning of dishware using said rinse aid composition, the use of a structural polypeptide in a machine dishwasher rinse aid composition and the use of the composition in a process of cleaning soiled dishware.

### CROSS REFERENCE TO RELATED APPLICATIONS

This application is a U.S. National Stage of PCT/EP2024/052456, international filing date Feb. 1, 2024, which claims priority to European Application No. 23154767.0, filing date Feb. 2, 2023.

### REFERENCE TO SEQUENCE LISTING IN ELECTRONIC FORMAT

The contents of the electronic sequence listing (558-122-pct-sequence-listing.xml; Size: 14,354 bytes; and Date of Creation: Jan. 29, 2024) is herein incorporated by reference in its entirety.

The present invention relates to a rinse aid composition for dishwashers comprising a structural polypeptide, a method for machine cleaning of dishware using said rinse aid composition, the use of a structural polypeptide in a machine dishwasher rinse aid composition and the use of the composition in a process of cleaning soiled dishware.

### BACKGROUND OF THE INVENTION

The use of rinse aids is customary in household dishwashers as well as commercial and institutional machine dishwashers (i.e. the industrial and institutional (I&I) cleaning sector). In typical machine dishwashing processes (also denoted as automatic dishwashing, short ADW), the objects to be washed, such as tableware or cookware, soiled with food or other matter, are subjected to a number of treatments in a sequence of zones and/or cycles. The actual cleaning process is completed by a rinse cycle, wherein the dishware is subjected to a final rinse that serves to remove pre-final rinse water and its attendant detergent and soil residues. The rinse aid can be released in the liquid used for the treatment of the dishes by a dosing device of the dishwasher or can be part of an automatic dishwashing composition with corresponding release properties. Rinse aid formulations are often liquid solutions, but further forms, e.g. prilled, pastilled or granular solids are also known.

Actual rinse aids have to meet a complex application profile including good clear rinsing properties, low tendency of foaming and fast drying. To accomplish this, the rinse aids contain surfactants that lower the surface tension and improve the wetting action of the rinse water so that it drains from the surfaces of the dishware in thin sheets rather than forming droplets, leaving no streaks, no filming and no spotting. By avoiding the formation of drops of rinse liquor that still may contain dissolved solids and soil from the cleaning cycle, which would result in a residue upon evaporation, the formation of spots is prevented. Low foaming avoids traces of foam on the rinsed substrate. A further desired property of modern rinse aids is to allow fast drying of the surface of the dishware after the rinse aid is applied.

An established criterion for the selection of surfactants suitable as rinse aids is the so-called cloud point. The cloud point is defined as the temperature at which a 1 wt. % aqueous solution of the surfactant turns cloudy when warmed. It is believed that at temperatures at or above the cloud point the surfactant in the rinse agent is absorbed on the surface of the dishware and thereby reduces the solid-liquid interfacial energy and contact angle. The result is the formation of a continuous sheet which drains evenly from the surface and minimizes the formation of spots. Generally, high foaming surfactants have cloud points above the temperature of the rinse water or do not exhibit a cloud point at all, and accordingly, would not promote sheet formation, thereby resulting in spots.

WO 2005/047440 describes a rinse aid composition comprising at least one alcohol ethoxylate compound bearing an alkyl group with at the most 12 carbon atoms as sheeting agent, and an effective amount of a defoamer component. The defoamer component is selected from nonionic ethylene oxide type surfactants that are water soluble and have cloud points below the intended use temperature of the rinse aid composition. It is mentioned as an advantage that the employed alcohol ethoxylates are biodegradable, environmentally friendly, and generally nontoxic.

The use of rinse aids based on nonionic surfactants with a low cloud point does not always lead to very good rinsing results, in particular if the rinse liquor still contains a certain amount of soil particles that can be re-deposited on the dishware and/or the water hardness is too high. In those cases, the use of additional builders can be advantageous to avoid the formation of crystals, in particular on glass surfaces, or to improve the suspension of soil particles in the liquor. It is known that the addition of a polymer builder, e.g. a low molecular weight (partly) neutralized polyacrylic acid, to the rinse water can further reduce spotting, filming and/or streaking.

WO 2021/046285 describes a solid surfactant system for the use as rinse aid, comprising
(1) a solid copolymer surfactant comprising
   (i) at least one polymer P1), comprising polymerized units of at least one monomer selected from α,β-ethylenically unsaturated carboxylic acids, salts, anhydrides and mixtures thereof,
   (ii) at least one nonionic surfactant, and
(2) at least one additional surfactant and/or polymer.

The described system shall employ a high efficacy with regard to defoaming, sheeting of the surface, wetting and drying time.

There is a continuing need for a rinse aid composition with a high clear rinse efficacy with the lowest possible application quantities and at the same time excellent rinse properties. In particular, the new rinse aids should have at least one, preferably several, of the following properties: improved spotting and filming performance even when water of high hardness is employed, a high shine level, in particular on glasses and cutlery, good drying properties. The rinse aid composition should meet the consumer's demand for sustainable and safe products and be non-toxic, not environmentally harmful and safe for humans and animals.

It has now been found that, surprisingly, structural polypeptides, such as silk polypeptides, are suitable for the formulation of rinse aid compositions with improved application properties. Silk polypeptides are polymers that exhibit exceptional application properties and can impart rinse aid formulations with a variety of benefits, including improved spotting and filming performance and good drying properties. Structural polypeptides, such as silk polypeptides, are biocompatible, non-toxic and environmental friendly and suitable for the use in any type of rinse aid formulations, such as liquids and a component of a multicompartment dosage form.

### SUMMARY OF THE INVENTION

A first object of the invention is a rinse aid composition, comprising:
a) a structural polypeptide, and
b) at least one nonionic surfactant.

In a special embodiment, the rinse aid composition is a liquid and in particular an aqueous formulation that comprises water as component c).

In a special embodiment, the rinse aid composition comprises at least one functional additive (component d), selected from surfactants different from component b), builders, hydrotropes, defoamers, pH controlling agents, further additives and mixtures thereof.

In a further special embodiment, the rinse aid composition comprises at least one further additive, selected from bleaches, enzymes, optical brighteners, antiredeposition agents, antimicrobial agents, antioxidants, rheology modifiers, solubility modifiers stabilizing agents, corrosion inhibitors, dyes, fragrances, fillers, tableting aids, disintegrants, humectants, electrolytes, water conditioning agents and mixtures thereof.

A further object of the invention is a method for machine cleaning of dishware, in which the dishware to be cleaned is contacted with a rinse aid composition as defined above and in the following.

A further object of the invention is the use of a structural polypeptide, especially a silk polypeptide, in a rinse aid composition.

A further object of the invention is the use of a rinse aid composition, as defined above and in the following, in the treatment of soiled dishware in an automatic dishwasher for
providing good sheeting and wetting properties,
reducing spotting and filming of the dishware, in particular of glassware and cutlery,
imparting the dishware with a good shine,
preventing resoiling of the dishware,
imparting the dishware with a surface protection, in particular preventing corrosive changes of the surfaces of glassware,
the formulation of products with a low tendency of foaming,
reducing the surface tension of the dishware,
improving the drying of the dishware.

This summary of the invention does not necessarily describe all features of the present invention. Other embodiments will become apparent from a review of the ensuing detailed description.

### DETAILED DESCRIPTION OF THE INVENTION

Before the present invention is described in detail below, it is to be understood that this invention is not limited to the particular methodology, protocols and reagents described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

Preferably, the terms used herein are defined as described in “A multilingual glossary of biotechnological terms: (IUPAC Recommendations)”, Leuenberger, H. G. W, Nagel, B. and Kölbl, H. eds. (1995), Helvetica Chimica Acta, CH-4010 Basel, Switzerland).

Several documents are cited throughout the text of this specification. Each of the documents cited herein (including all patents, patent applications, scientific publications, manufacturer's specifications, instructions, GenBank Accession Number sequence submissions etc.), whether supra or infra, is hereby incorporated by reference in its entirety. Nothing herein is to be construed as an admission that the invention is not entitled to antedate such disclosure by virtue of prior invention.

In the following, the elements of the present invention will be described. These elements are listed with specific embodiments. However, it should be understood that they may be combined in any manner and in any number to create additional embodiments. The variously described examples and preferred embodiments should not be construed to limit the present invention to only the explicitly described embodiments. This description should be understood to support and encompass embodiments which combine the explicitly described embodiments with any number of the disclosed and/or preferred elements. Furthermore, any permutations and combinations of all described elements in this application should be considered disclosed by the description of the present application unless the context indicates otherwise.

The term “rinse aid” (specifically “dishwasher rinse aid”), as used herein, refers to an agent/composition used to prevent droplet formation, so that water drains from the surfaces in thin sheets, rather than forming droplets. Particularly, the rinse aid prevents “spotting” on dishes such as glassware (caused by droplets of water drying and leaving behind dissolved limescale minerals), and can also improve drying performance as there is less water remaining to be dried. A thinner sheet of water also has a much larger surface area than a droplet of the same volume, which increases the likelihood of water molecules evaporating.

More particularly, a rinse aid reduces the surface tension of the water and thus ensures that the water film on dishes and cutlery runs off better when washing dishes in the dishwasher. It prevents water stains and limescale deposits from forming and makes dishes and cutlery shine. A rinse aid reservoir is usually located on the inside of the dishwasher door.

Structural polypeptides, such as silk polypeptides, are particularly advantageous for use in rinse aid compositions which must meet a complex property profile. The rinse aid of the invention has at least one, preferably two, three or more of the following advantages:
The composition of the invention is generally suitable for use in cleaning and rinsing dishware and cutlery in need of a composition providing good sheeting, wetting and drying properties.
The composition of the invention leads to an efficient reduction of spotting and filming. It lowers the surface tension and improves the wetting action of the rinse water so that it drains from the surfaces of the dishware in thin sheets rather than forming droplets. After the cleaning process the dishware and in particular glassware and cutlery has a good shine and shows remarkably less water-marks, smears and/or spots in comparison to conventional products from the prior art.
The structural polypeptides, in particular silk polypeptides, are particularly suitable for the formulation of products with a low tendency of foaming. They are characterised by good compatibility with nonionic low foaming surfactants to provide cleaning and rinsing efficacy without introducing excessive foaming into the formulation. The use of defoamers can be dispensed with or their application quantity reduced. Low foaming avoids traces of foam on the rinsed substrate.
The rinse aids of the invention allow fast drying of the surface of the dishware.
The composition of the invention is suitable to impart the dishware with a reduced surface tension. The contact angle of deionized water on dishware, in particular glasses, treated in a dishwasher with the rinse aid composition of the invention is remarkably reduced in comparison to conventional products from the prior art.
The composition of the invention is suitable to impart the dishware with a surface protection. In particular, it does not corrosively change the surfaces of glassware, even upon repeated use, in particular does not cause clouding, smearing or scratches, nor iridescence of glass surfaces.
The composition shows effective action even with very low application quantities. In many cases, the use of structural polypeptides, such as silk polypeptides, allows a reduction of the amount of surfactants in the formulation.
The structural polypeptides, in particular the silk proteins, contained in the rinse aid compositions according to the invention are biocompatible, non-toxic, not environmentally harmful and safe for humans and animals.

Without wishing to be bound by any theory, it is believed that the employed structural polypeptides, in particular silk polypeptides, are suitable for a surface modification of the dishware that imparts the dishware with improved properties. The structural polypeptide forms a coating on the surfaces that allows efficient drainage of the wash liquor and/or rinsing water. This helps prevent the generation of aqueous droplets which, upon drying, can result in deposition of residues on the dishware surface and formation of visible spots or streaks. The structural polypeptides impart dishware, cutlery and similar hard surfaces with good “sheeting properties”, i.e. they lead to the formation of a continuous sheet which drains evenly from the surface and minimizes the formation of spots. The structural polypeptides can be used advantageously in combination with surfactants, in particular nonionic surfactants with a low cloud point. It can be assumed that the rinse aid is absorbed on the surface of the ware at temperatures at or above the cloud point of the surfactant and thereby reduces the solid-liquid interfacial energy and contact angle. Thus, the use of the structural polypeptide in the rinse aid composition enables good water drainage during the rinsing process of and leaves a protection against surface damage and resoiling. Generally, a low contact angle is associated with improved sheeting. That is, compositions with lower contact angles will form droplets on a substrate with a larger surface area than compositions with higher contact angles. The increased surface area results in a faster drying time, with fewer spots formed on the substrate.

In the sense of the present application, the term dishware encompasses all kinds of soiled objects that can be subjected to an automated cleaning process in a dishwasher. Thus, the term dishware encompasses dinnerware (tableware), cookware, cutlery, kitchen utensils, and other items for practical and decorative purposes.

The rinse aid of the invention may be in any form, suitable for consumer and I&I products, including the use in automatic dosing machines. In a preferred embodiment, the rinse aid composition is in liquid form.

The term (meth)acrylate as used in the present application includes both, methacrylate and acrylate derivatives.

### Component a) (Structural Polypeptide)

In the context of the present invention, the terms “polypeptide” and “protein” are used interchangeably. They refer to a long chain of amino acids with peptide linkage, e.g. one that is at least 30 amino acids long.

The term “structural polypeptide”, as used herein, refers to any polypeptide which comprises repeat units (repeating building blocks) made of amino acids. The structural polypeptide preferably has the ability to perform polypeptide assembly. In particular, the structural polypeptide is capable of forming protein complexes (aggregates) in formulations, e.g. hydrogels in aqueous formulations. The structural polypeptide may be selected from the group consisting of silk polypeptide (including fibroin), keratin, fibroin, collagen, and elastin or variants or combinations thereof. The structural polypeptide is particularly a recombinant or synthetic structural polypeptide. The structural polypeptide is preferably a (recombinant or synthetic) silk polypeptide, such as a (recombinant or synthetic) spider silk polypeptide. An exemplarily process for producing a silk polypeptide is described in WO 2006/008163 and in WO 2011/120690.

The term “silk polypeptide”, as used herein, refers to a polypeptide which shows, in comparison to other polypeptides, a quite aberrant amino acid composition. In particular, a silk polypeptide possesses large quantities of hydrophobic amino acids such as glycine or alanine. In addition, a silk polypeptide contains highly repetitive amino acid sequences or repetitive units (repeat units, modules), especially in their large core domain. Based on DNA analysis, it was shown that all silk polypeptide are chains of repetitive units which further comprise a limited set of distinct shorter peptide motifs. The expressions “peptide motif” and “consensus sequence” can be used interchangeably herein. Generally, the silk consensus sequences can be grouped into four major categories: GPGXX, GGX, Ax or (GA)n and spacers. These categories of peptide motifs in silk polypeptides have been assigned structural roles. For example, it has been suggested that the GPGXX motif is involved in a R-turn spiral, probably providing elasticity. The GGX motif is known to be responsible for a glycine-rich 3₁-helix. Both GPGXX and GGX motifs are thought to be involved in the formation of an amorphous matrix that connects crystalline regions, thereby providing elasticity of the fiber. Alanine-rich motifs typically contain 6-9 residues and have been found to form crystalline O-sheets. The spacers typically contain charged groups and separate the iterated peptide motifs into clusters. The silk polypeptide can perform polypeptide assembly.

Fibroin is a structural polypeptide and a silk polypeptide in the sense of the invention.

The silk polypeptide is particularly a recombinant or synthetic silk polypeptide.

Preferably, the (recombinant or synthetic) silk polypeptide is a (recombinant or synthetic) spider silk polypeptide.

The term “polypeptide-assembly”, as used herein, refers to a process in which a disordered system of pre-existing polypeptides forms an organized structure or pattern as a consequence of specific, local interactions (e.g. van der Waals forces, hydrophobic interactions, hydrogen bonds, and/or salt-bridges, etc.) among the polypeptides themselves, without external direction or trigger although external factors might influence speed and nature of polypeptide-assembly. This particularly means that when two or more disordered and/or unfolded polypeptides are brought into contact, they interact with each other and consequently form a three-dimensional structure. The change from a disordered system to an organized structure or pattern during self-polypeptide assembly is characterized by a transition from a fluid state to a gel-like and/or solid state and a corresponding increase in viscosity. The transition from a fluid state to a gel-like state can be monitored, for example, by optical measurement or rheology measurement. These techniques are known to the skilled person. The transition from a fluid state to a solid state can be monitored, for example, using optical methods.

Preferably, the structural polypeptide conducting polypeptide assembly is a (recombinant or synthetic) silk polypeptide, such as a (recombinant or/synthetic) spider silk polypeptide.

The term “polypeptide aggregates” (or polypeptide complexes), as used herein, refers to polypeptide structures which are formed as a result of polypeptide self-assembly. In the process of polypeptide self-assembly, multiple copies/units of polypeptides self-aggregate into a body or mass without external direction or trigger although external factors might influence speed and nature of self-polypeptide assembly. In the polypeptide aggregates, the different polypeptides are connected with or attached to each other via covalent (e.g. disulfide bridges) and/or non-covalent interactions (e.g. van der Waals forces, hydrophobic interactions, hydrogen bonds, and/or salt-bridges). It should be clear that a polypeptide aggregate encompasses at least two polypeptides. In the context of the present invention, the self-assembly of (recombinant or/synthetic) silk polypeptides is described. During the process of silk polypeptide self-assembly, silk polypeptide aggregates (silk polypeptide complexes) are formed.

The term “hydrogel”, as used herein, refers to a structure that is formed if the concentration of structural polypeptides is high enough to build a continuous network by which the liquid component is immobilized. Said network is preferably formed by polypeptide assembly of the structural polypeptides providing the basis of the hydrogel. In particular, the hydrogel is a hydrophilic polymeric network of structural polypeptides. Said network is stabilized by chemical and/or physical interactions between the structural polypeptides. The network is dispersed throughout an immobilized aqueous phase. The hydrophilicity and stability of the hydrogel permits the penetration and absorption of water (swelling) without dissolving, thus, maintaining its three-dimensional (3D) structure and function.

A preferred embodiment of a hydrogel is a flowable hydrogel. The term “flowable hydrogel”, as used herein, refers to a hydrogel that is capable of flowing, in particular when it is exposed to the force of gravity. A flowable hydrogel is in a liquid state (in the sense that it is not yet self-supporting, meaning that it retain a shape imparted to it without shape-stabilizing encasement). The followability of a hydrogel can easily be determined by the skilled person, e.g. by rheology or viscosity measurements. The followability measurements are preferably preformed under standard conditions (20° C.). Methods for determining the viscosity of gels are described in detail in the following.

Alternatively, the hydrogel is a non-flowable hydrogel. This hydrogel can be converted to a flowable hydrogel by shear-thinning. The same holds for structural polypeptides in the sense of the invention that are in a solid form.

Preferably, the structural polypeptide employed according to the invention is in the form of a hydrogel. More preferably, the structural polypeptide in the form of a hydrogel is a silk polypeptide. In particular, the structural polypeptide in the form of a hydrogel is a recombinant or synthetic silk polypeptide.

Preferably, the structural polypeptide employed according to the invention is in the form of a flowable hydrogel. More preferably, the structural polypeptide in the form of a flowable hydrogel is a silk polypeptide. In particular, the structural polypeptide in the form of a flowable hydrogel is a recombinant or synthetic silk polypeptide.

The hydrogel hereinafter is also referred to as silk protein gel or silkgel. The manufacture of hydrogel is described for example in WO2020035361, WO2022258500 or WO2022258499.

In a preferred embodiment, the rinse aid composition according to the invention comprises a structural polypeptide which can form polypeptide aggregates. In particular, said polypeptide has the potential to assemble into fibrillary structures (i.e. fibrillary aggregates (complexes) of structural polypeptides).

It is preferred that the structural polypeptide is selected from silk polypeptides, keratin, collagen, elastin and combinations thereof. In one embodiment, the silk polypeptide is fibroin. In particular, the structural polypeptide is a recombinant polypeptide, e.g. a recombinant silk polypeptide, keratin, collagen or elastin.

It is more preferred that the structural polypeptide is a silk polypeptide, in particular a recombinant silk polypeptide.

In a preferred embodiment, the (recombinant) silk polypeptide is a spider silk polypeptide. A suitable spider silk polypeptide is a major ampullate silk polypeptide, such as a dragline silk polypeptide, a minor ampullate silk polypeptide, or a flagelliform silk polypeptide of an orb-web spider. Particularly, the silk polypeptide is a spider silk polypeptide, more particularly a recombinant spider silk polypeptide.

In a preferred embodiment, the silk polypeptide comprises or consists of 25 to 4000 amino acids. It is even more preferred that the silk polypeptide comprises or consists of 30 to 1500 amino acids, in particular 35 to 1200 amino acids, in a special embodiment, the silk polypeptide comprises or consists of 60 to 600 amino acids.

In one preferred embodiment, the silk polypeptide consists of a single unit of amino acids. This embodiment is defined in that the protein chain does not have units of several (at least two) of the same or similar sequence motifs. In this embodiment, the silk polypeptide preferably consists of 25 to 250 amino acids, in particular 30 to 150 amino acids.

In an alternative preferred embodiment, the silk polypeptide is a polypeptide with an amino acid sequence which comprises or consists of at least 50% multiple copies of repetitive units. The amino acid sequence may consist of up to 100% multiple copies of repetitive units. More preferably, the silk polypeptide is a polypeptide with an amino acid sequence which comprises or consists of at least 50%, particularly at least 60%, particularly at least 65%, particularly at least 70%, particularly at least 75%, particularly particularly at least 80%, particularly at least 85%, particularly at least 90%, particularly at least 95%, or especially at least 99% multiple copies of repetitive units or of even 100% multiple copies of repetitive units. Said repetitive units may be identical or different.

If the amino acid sequence of the silk polypeptide is a polypeptide that comprises or consists of multiple copies of repetitive units, each repetitive unit preferably comprises or consists of 25 to 250 amino acids, in particular 30 to 150 amino acids.

If the amino acid sequence of the silk polypeptide is a polypeptide that comprises or consists of multiple copies of repetitive units, the total number of amino acids in all repetitive units is preferably in a range of 25 to 3000 amino acids, more preferably 30 to 1500 amino acids, in particular 35 to 1200 amino acids, especially 60 to 600 amino acids.

In a preferred embodiment, the silk polypeptide comprises or consists of at least two identical repetitive units. For example, the silk polypeptide comprises or consists of from 2 to 96 repetitive units, e.g. 2, 3, 4, 5, 6, 7, 8, 9, 10, 11, 12, 13, 14, 15, 16, 17, 18, 19, 20, 21, 22, 23, 24, 25, 26, 27, 28, 29, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, or 96 repetitive units.

In particular, the repetitive units are independently selected from the group consisting of
module C having an amino acid sequence according to SEQ ID NO: 1 (GSSAAAAAAAASGPGGYGPENQGPSGPGGYGPGGP) or variants thereof,
module C^{Cys} having an amino acid sequence according to SEQ ID NO: 2 (GSSAAAAAAAASGPGGYGPENQGPCGPGGYGPGGP) or variants thereof,
module C^{Lys} having an amino acid sequence according to SEQ ID NO: 3 (GSSAAAAAAAASGPGGYGPKNQGPSGPGGYGPGGP) or variants thereof.

Module C^{Cys} (SEQ ID NO: 2) is a variant of module C (SEQ ID NO: 1). In this module, the amino acid Ser at position 25 has been replaced by the amino acid Cys. Module C^{Lys} (SEQ ID NO: 3) is also a variant of module C (SEQ ID NO: 1). In this module, the amino acid Glu at position 20 has been replaced by the amino acid Lys.

The module C variant differs from the reference module C from which it is derived by up to 1, 2, 3, 4, 5, 6, 7, 8, 9, 10, 11, 12, 13, 14 or 15 amino acid changes in the amino acid sequence (i.e. substitutions, additions, insertions, deletions, N-terminal truncations and/or C-terminal truncations). Such a module variant can alternatively or additionally be characterized by a certain degree of sequence identity to the reference module from which it is derived. Thus, the module C variant has a sequence identity of at least 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99% or even 99.9% to the respective reference module C. Preferably, the sequence identity is over a continuous stretch of at least 5, 10, 15, 18, 20, 24, 27, 28, 30, 34 or more amino acids, preferably over the whole length of the respective reference module C.

The sequence identity may be at least 80% over the whole length, may be at least 85% over the whole length, may be at least 90% over the whole length, may be at least 95% over the whole length, may be at least 98% over the whole length, or may be at least 99% over the whole length of the respective reference module C. Alternatively, the sequence identity may be at least 80% over a continuous stretch of at least 5, 10, 15, 18, 20, 24, 28, or 30 amino acids, may be at least 85% over a continuous stretch of at least 5, 10, 15, 18, 20, 24, 28, or 30 amino acids, may be at least 90% over a continuous stretch of at least 5, 10, 15, 18, 20, 24, 28, or 30 amino acids, may be at least 95% over a continuous stretch of at least 5, 10, 15, 18, 20, 24, 28, or 30 amino acids, may be at least 98% over a continuous stretch of at least 5, 10, 15, 18, 20, 24, 28, or 30 amino acids, or may be at least 99% over a continuous stretch of at least 5, 10, 15, 18, 20, 24, 28, or 30 amino acids of the respective reference module C.

A fragment (or deletion) variant of module C has preferably a deletion of up to 1, 2, 3, 4, 5, 6, 7, 8, 9, 10, 11, 12, 13, 14, or 15 amino acids at its N-terminus and/or at its C-terminus. The deletion can also be internally.

Additionally, the module C variant or fragment is only regarded as a module C variant or fragment within the context of the present invention if the modifications with respect to the amino acid sequence on which the variant or fragment is based do not negatively affect the ability of the silk polypeptide to treat dishware in a dishwasher. The skilled person can readily assess whether the silk polypeptide comprising a module C variant or fragment is still capable of treating dishware. In this respect, it is referred to the examples comprised in the experimental part of the present patent application.

C^{Cys} or C^{Lys} variants may also be encompassed by the present invention. Regarding the C^{Cys} or C^{Lys} variants, the same explanations/definitions apply which have been made with respect to the module C variant (see above).

It is still even more preferred that the silk polypeptide is selected from the group consisting of (C)ₘ, (C)ₘC^{Cys} (C)ₘC^{Lys}, C^{Cys}(C)ₘ, C^{Lys}(C)ₘ, (C^{Cys})ₘ and (C^{Lys})ₘ, wherein m is an integer of 1 to 96.

It is most preferred that the silk polypeptide is selected from the group consisting of C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, C₃₀, C₃₁, C₃₂, C₃₃, C₃₄, C₃₅, C₃₆, C₃₇, C₃₈, C₃₂, C₃₉, C₄₀, C₄₁, C₄₂, C₄₃, C₄₄, C₄₅, C₄₆, C₄₇, C₄₈,
(C)₁C^{Cys}, (C)₂C^{Cys}, (C)₃C^{Cys}, (C)₄C^{Cys}, (C)₅C^{Cys}, (C)₆C^{Cys}, (C)₇C^{Cys}, (C)₈C^{Cys}, (C)₉C^{Cys}, (C)₁₀C^{Cys}, (C)₁₁C^{Cys}, (C)₁₂C^{Cys}, (C)₁₃C^{Cys}, (C)₁₄C^{Cys}, (C)₁₅C^{Cys}, (C)₁₆C^{Cys}, (C)₁₇C^{Cys}, (C)₁₈C^{Cys}, (C)₁₉C^{Cys}, (C)₂₀C^{Cys}, (C)₂₁C^{Cys}, (C)₂₂C^{Cys}, (C)₂₃C^{Cys}, (C)₂₄C^{Cys}, (C)₂₅C^{Cys}, (C)₂₆C^{Cys}, (C)₂₇C^{Cys}, (C)₂₈C^{Cys}, (C)₂₉C^{Cys}, (C)₃₀C^{Cys}, (C)₃₁C^{Cys}, (C)₃₂C^{Cys}, (C)₃₃C^{Cys}, (C)₃₄C^{Cys}, (C)₃₅C^{Cys}, (C)₃₆C^{Cys}, (C)₃₇C^{Cys}, (C)₃₈C^{Cys}, (C)₃₂C^{Cys}, (C)₃₉C^{Cys}, (C)₄₀C^{Cys}, (C)₄₁C^{Cys}, (C)₄₂C^{Cys}, (C)₄₃C^{Cys}, (C)₄₄C^{Cys}, (C)₄₅C^{Cys}, (C)₄₆C^{Cys}, (C)₄₇C^{Cys}, (C)₄₈C^{Cys},
(C)₁C^{Lys}, (C)₂C^{Lys}, (C)₃C^{Lys}, (C)₄C^{Lys}, (C)₅C^{Lys}, (C)₆C^{Lys}, (C)₇C^{Lys}, (C)₈C^{Lys}, (C)₉C^{Lys}, (C)₁₀C^{Lys}, (C)₁₁C^{Lys}, (C)₁₂C^{Lys}, (C)₁₃C^{Lys}, (C)₁₄C^{Lys}, (C)₁₅C^{Lys}, (C)₁₆C^{Lys}, (C)₁₇C^{Lys}, (C)₁₈C^{Lys}, (C)₁₉C^{Lys}, (C)₂₀C^{Lys}, (C)₂₁C^{Lys}, (C)₂₂C^{Lys}, (C)₂₃C^{Lys}, (C)₂₄C^{Lys}, (C)₂₅C^{Lys}, (C)₂₆C^{Lys}, (C)₂₇C^{Lys}, (C)₂₈C^{Lys}, (C)₂₉C^{Lys}, (C)₃₀C^{Lys}, (C)₃₁C^{Lys}, (C)₃₂C^{Lys}, (C)₃₃C^{Lys}, (C)₃₄C^{Lys}, (C)₃₅C^{Lys}, (C)₃₆C^{Lys}, (C)₃₇C^{Lys}, (C)₃₈C^{Lys}, (C)₃₂C^{Lys}, (C)₃₉C^{Lys}, (C)₄₀C^{Lys}, (C)₄₁C^{Lys}, (C)₄₂C^{Lys}, (C)₄₃C^{Lys}, (C)₄₄C^{Lys}, (C)₄₅C^{Lys}, (C)₄₆C^{Lys}, (C)₄₇C^{Lys}, (C)₄₈C^{Lys},
C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₉, C^{Cys}(C)₁₀, C^{Cys}(C)₁₁, C^{Cys}(C)₁₂, C^{Cys}(C)₁₃, C^{Cys}(C)₁₄, C^{Cys}(C)₁₅, C^{Cys}(C)₁₆, C^{Cys}(C)₁₇, C^{Cys}(C)₁₈, C^{Cys}(C)₁₉, C^{Cys}(C)₂₀, C^{Cys}(C)₂₁, C^{Cys}(C)₂₂, C^{Cys}(C)₂₃, C^{Cys}(C)₂₄, C^{Cys}(C)₂₅, C^{Cys}(C)₂₆, C^{Cys}(C)₂₇, C^{Cys}(C)₂₈, C^{Cys}(C)₂₉, C^{Cys}(C)₃₀, C^{Cys}(C)₃₁, C^{Cys}(C)₃₂, C^{Cys}(C)₃₃, C^{Cys}(C)₃₄, C^{Cys}(C)₃₅, C^{Cys}(C)₃₆, C^{Cys}(C)₃₇, C^{Cys}(C)₃₈, C^{Cys}(C)₃₉, C^{Cys}(C)₄₀, C^{Cys}(C)₄₁, C^{Cys}(C)₄₂, C^{Cys}(C)₄₃, C^{Cys}(C)₄₄, C^{Cys}(C)₄₅, C^{Cys}(C)₄₆, C^{Cys}(C)₄₇, C^{Cys}(C)₄₈,
C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₉, C^{Lys}(C)₁₀, C^{Lys}(C)₁₁, C^{Lys}(C)₁₂, C^{Lys}(C)₁₃, C^{Lys}(C)₁₄, C^{Lys}(C)₁₅, C^{Lys}(C)₁₆, C^{Lys}(C)₁₇, C^{Lys}(C)₁₈, C^{Lys}(C)₁₉, C^{Lys}(C)₂₀, C^{Lys}(C)₂₁, C^{Lys}(C)₂₂, C^{Lys}(C)₂₃, C^{Lys}(C)₂₄, C^{Lys}(C)₂₅, C^{Lys}(C)₂₆, C^{Lys}(C)₂₇, C^{Lys}(C)₂₈, C^{Lys}(C)₂₉, C^{Lys}(C)₃₀, C^{Lys}(C)₃₁, C^{Lys}(C)₃₂, C^{Lys}(C)₃₃, C^{Lys}(C)₃₄, C^{Lys}(C)₃₅, C^{Lys}(C)₃₆, C^{Lys}(C)₃₇, C^{Lys}(C)₃₈, C^{Lys}(C)₃₉, C^{Lys}(C)₄₀, C^{Lys}(C)₄₁, C^{Lys}(C)₄₂, C^{Lys}(C)₄₃, C^{Lys}(C)₄₄, C^{Lys}(C)₄₅, C^{Lys}(C)₄₆, C^{Lys}(C)₄₇ and C^{Lys}(C)₄₈.

In one embodiment, the silk polypeptide comprises an amino terminal TAG, e.g. consisting of the amino acid sequence MASMTGGQQMG (SEQ ID NO: 4). In another embodiment, the silk polypeptide comprises an amino terminal TAG and a Linker, the Linker e.g. consisting of the amino acid sequence RGSM (SEQ ID NO: 5).

In one example, the silk polypeptide comprises 16 times module C (=C₁₆) and has the amino acid sequence according to SEQ ID NO: 6 (with a TAG according to SEQ ID NO: 4 and a Linker according to SEQ ID NO: 5 at the N-terminus).

In another example, the silk polypeptide comprises 16 C^{Lys} modules (C^{Lys}₁₆) (SEQ ID NO: 7).

In another example, the silk polypeptide comprises 17 modules, wherein the first module (N-terminal) or the last module (C-terminal) is a C^{Cys} module (SEQ ID NO: 2) and the 16 other modules are C modules (SEQ ID NO: 1). A specific example is (C)₁₆C^{Cys} (SEQ ID NO: 8)

In another example, the silk polypeptide comprises 17 modules, wherein the first module (N-terminal) or the last module (C-terminal) is a C^{Lys} module (SEQ ID NO: 3) and the 16 other modules are C modules (SEQ ID NO: 1).

Exemplarily larger silk polypeptides based on C modules are the silk polypeptide C₃₂ (32 times module C) having the amino acid sequence according to SEQ ID NO: 9 and the silk polypeptide C₄₈ (48 times module C) having the amino acid sequence according to SEQ ID NO: 10.

Particularly, the above-described silk polypeptide consists exclusively of repetitive units. In other words, the silk polypeptide particularly does not comprise/is free of non-repetitive units. The only component that can additionally be present as part of the silk polypeptide is a tag or moiety, e.g. allowing easy transcription of said silk polypeptide in expression systems and/or allowing easy isolation of said silk polypeptide from the expression systems. Said tag may be a his tag or a flag tag.

The rinse aid composition according to the invention preferably comprising from 0.0005 to 2.5% by weight, more preferably from 0.001 to 2.0% by weight, in particular from 0.05 to 1.5% by weight, e.g. 0.0005, 0.0006, 0.0007, 0.0008, 0.0009, 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, or 2.5 by weight, based on the total weight of the composition, of at least one structural polypeptide (component a)).

For the formulation of the rinse aid composition the structural polypeptide a) can be employed in solid form, e.g. in the form of a powder. The structural polypeptide a) can also be employed in form of a solution. Preferred solvents are water, at least partly water-miscible organic solvents and mixtures thereof. The structural polypeptide a) can also be employed in form of a gel. The gel form preferably comprises the structural polypeptide in an amount of 0.5 to 30% by weight, more preferably 1 to 20% by weight, e.g. 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 by weight, based on the total weight of the gel.

### Component b) (Nonionic Surfactant)

Suitable as nonionic surfactant b) are in general nonionic surfactants having at least one nonpolar group and at least one polar group and comprising a polyether group. In principle, the structural polypeptides a), in particular silk polypeptides, are compatible with a great variety of nonionic surfactants useful for detersive purposes.

Suitable nonionic surfactants can be obtained by the modification of a hydrophobic compound with hydrophilic alkylene oxide moieties. Generally, any hydrophobic compound having a hydroxyl, carboxyl, amino or amido group with a reactive hydrogen atom can be condensed with alkylene oxides, or a polyhydration product thereof, to form a nonionic surface-active agent. The alkylene oxide is preferably selected from ethylene oxide (EO), 1,2-propylene oxide (PO), 1,2-butylene oxide (BO), 1,2-pentylene oxide and mixtures thereof. The ether component here may be derived from random copolymers and block copolymers. In a preferred embodiment, the alkylene oxide is preferably selected from ethylene oxide and mixtures of ethylene oxide with propylene oxide and/or butylene oxide. The length of the hydrophilic polyoxyalkylene chain which is condensed with a hydrophobic compound can be readily adjusted to yield a water soluble or water dispersible compound having the desired degree of balance between hydrophilic and hydrophobic properties.

In one embodiment, the nonionic surfactants b) are selected from compounds with a hydrophilic-lipophilic balance (HLB) value in the range of 2 to 17.

Examples of classes of compounds useful as nonionic surfactants b) are:

### (i) Ethoxylated Alcohols

In one embodiment, the nonionic surfactants b) are selected from condensation products of one mole of a saturated or unsaturated, straight-chain or branched alcohol having from 1 to 30 carbon atoms, preferably 4 to 24 carbon atoms, in particular 6 to 18 carbon atoms with 2 to 100 moles, preferably 3 to 50 moles, of ethylene oxide. The alcohol moiety can be derived from a certain alcohol having a specific number of carbon atoms within the above-mentioned range of carbon atoms or mixtures of alcohols in the above-mentioned range.

Particularly preferred are the condensation products of alcohols having an alkyl group containing from 8 to 20 carbon atoms with from about 2 to about 25 moles of ethylene oxide per mole of alcohol.

In one embodiment, the nonionic surfactant b) is selected from compounds of the formula R—O-(EO)ₙ₁, wherein R is straight-chain or branched C₄-C₂₄-alkyl, preferably C₆-C₁₈-alkyl, in particular C₆-C₁₂-alkyl. Preferably, n₁ is 2 to 25, more preferably 3 to 12.

Examples of commercially available compounds of this type include certain Genapol® surfactants marketed by Clariant, e.g. Genapol® X089, an ethoxylated C₁₃-rich iso-C₁₁-C₁₄ alcohol. Further examples are C₁₆C₁₈ fatty alcohol ethoxylates, commercially available as Lutensol® AT brands from BASF SE. Further examples are C₁₃C₁₅ oxo alcohol ethoxylates, commercially available as Lutensol® AO brands from BASF SE. Further examples are C₁₀C₁₈ alcohol ethoxylates, commercially available as Lutensol® M brands from BASF SE. Further examples are C₁₃ oxoalcohol ethoxylates, commercially available as Lutensol® TO brands from BASF SE. Further examples are Guerbetalcohol alkoxylates, commercially available as Lutensol® XP and XL brands from BASF SE.

(ii) Block Copolymers of Fatty Alcohols with EO and with PO and/or BO

In another embodiment, the nonionic surfactants b) are selected from condensation products of one mole of a saturated or unsaturated, straight-chain or branched alcohol having from 6 to 30 carbon atoms, preferably 8 to 24 carbon atoms, with ethylene oxide and at least one further alkylene oxide, selected from propylene oxide, butylene oxide and mixtures thereof. Preferred are ethoxylated and propoxylated and/or butoxylated C₆-C₁₈ fatty alcohols. The degree of ethoxylation is preferably from 2 to 50, more preferably from 3 to 30. The degree of propoxylation is preferably from 1 to 10, more preferably of from 1 to 5, in particular 1, 2 or 3. The degree of buthoxylation, if present, is preferably 1 or 2, in particular 1.

In another embodiment, the nonionic surfactant b) is selected from compounds of the formula R—O-(EO)ₙ₁(PO)ₘ₁, wherein R is straight-chain or branched C₄-C₂₄-alkyl, preferably, C₆-C₁₈-alkyl, in particular C₆-C₁₂-alkyl. Preferably, n₁ is 2 to 8, more preferably 3 to 6, and m₁ is 1 or 2.

In another embodiment, the nonionic surfactant b) is selected from compounds of the formula R—O-(EO)ₙ₁(BO)ₘ₁, wherein R is straight-chain or branched C₄-C₂₄-alkyl, preferably, C₆-C₁₈-alkyl, in particular C₆-C₁₂-alkyl. Preferably, n₁ is 2 to 6, more preferably 3, 4 or 5 and m₁ is 1 or 2, preferably 1.

Examples of commercially available compounds of this type include certain Genapol® surfactants marketed by Clariant, e.g. Genapol® EP 2454, a lauryl alcohol EO/PO adduct, or Genapol® EP 2464, a C₁₂/C₁₅ oxoalcohol EO/PO addition product. Further examples are EP/PO, EO/PO/EO and PO/EO/PO block copolymers, commercially available as Pluronic® PE and RPE brands from BASF SE.

(iii) EO/PO Block Copolymers from Polyvalent Initiators

In another embodiment, the nonionic surfactants b) are selected from EO/PO block copolymers based upon at least one polyvalent initiator, preferably selected from ethylene glycol, propylene glycol, glycerol, trimethylolpropane, ethylenediamine and mixtures thereof. One embodiment are difunctional compounds derived from initiators with two reactive hydrogens. In a special embodiment, EO/PO block copolymers are formed by condensing ethylene oxide with a hydrophobic base formed by the addition of propylene oxide to the two hydroxyl groups of propylene glycol. This hydrophobic portion has a number average molecule weight from about 1000 to about 4000. Ethylene oxide is then added to sandwich this core moiety between hydrophilic groups. Preferably, the number average molecular weight of the (hydrophobic) core moiety is in a range of from 10 to 90% by weight of the final molecule. Preferably, the number average molecular weight of the (hydrophilic) end groups is in a range of from 10 to 90% by weight of the final molecule. Examples of commercially available compounds of this type include certain Pluronic® surfactants, marketed by BASF SE and Genapol® surfactants marketed by Clariant. Another class of suitable nonionic surfactants b) are tetrafunctional block copolymers derived from the sequential addition of propylene oxide and ethylene oxide to ethylenediamine. The number average molecular weight of the propylene oxide units ranges from about 500 to about 7000, and the number average molecular weight of the hydrophilic ethylene oxide units ranges from about 10% by weight to about 80% by weight of the molecule. Examples of commercially available compounds of this type include the Tetronic® compounds, marketed by BASF SE.

### (iv) Ethoxylated Carboxylic Acids (Polyethylene Glycol Ester)

In another embodiment, the nonionic surfactants b) are selected from condensation products of one mole of a saturated or unsaturated, straight-chain or branched carboxylic acid having from 6 to 30 carbon atoms, preferably 8 to 24 carbon atoms, with 2 to 100 moles, preferably 3 to 50 moles, of ethylene oxide. The acid moiety can consist of a certain acids having a specific number of carbon atoms within the above-mentioned range of carbon atoms or mixtures of acids in the above-mentioned range. Particularly preferred are the condensation products of acids having an alkyl group containing from 8 to 20 carbon atoms with from about 2 to about 25 moles of ethylene oxide per mole of alcohol.

### (v) Polyhydroxy Fatty Acid Amides

In another embodiment, the nonionic surfactants b) are selected from polyhydroxy fatty acid amides. Suitable are compounds of the formula(I) R²CONR¹Z, wherein
R¹ is selected from H, C₁-C₄ alkyl, 2-hydroxy ethyl and 2-hydroxy propyl,
R² is selected from straight-chain or branched, saturated or unsaturated C₄-C₃₀ hydrocarbyl,
Z is an alcohol containing moiety having 2 or more (e.g. 3, 4, 5, 6 or more) hydroxy groups, or an alkoxylated derivative (preferably an ethoxylated and/or propoxylated derivative) thereof.

Preferably, R¹ is selected from C₁-C₄ alkyl, in particular methyl.

Preferably, R² is selected from straight-chain C₅-C₁₉ alkyl and C₅-C₁₉ alkenyl, more preferably straight-chain C₉-C₁₇ alkyl and C₉-C₁₇ alkenyl, and mixture thereof.

Preferably, Z is derived from glycerol and units of at least one reducing sugar, like glucose, fructose, maltose, lactose, glactose, mannose etc. In a special embodiment, Z is a glycityl moiety.

### (vi) Alkylpolysaccharides

In another embodiment, the nonionic surfactants b) are selected from alkylpolysaccharides, having a hydrophobic group containing from about 6 to about 30 carbon atoms, preferably from about 10 to about 16 carbon atoms and a polysaccharide, e.g. a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g. glucose, galactose and galactosyl moieties can be substituted for the glucosyl moieties. Optionally the hydrophobic group is attached at the 2-, 3-, 4-, etc. positions thus giving a glucose or galactose as opposed to a glucoside or galactoside. The intersaccharide bonds can be, e.g. between the one position of the additional saccharide units and the 2-, 3-, 4-, and/or 6-positions on the preceding saccharide units.

(vii) Fatty Acid Amide Alkoxylates

In another embodiment, the nonionic surfactants b) are selected from fatty acid amide alkoxylates. Suitable fatty acid amide surfactants are compounds of the formula R⁶CON(R⁷)₂ wherein R⁶ is an alkyl group containing from 7 to 21, preferably from 9 to 17 carbon atoms and each R⁷ is selected from the group consisting of hydrogen, C₁-C₄ alkyl, C₁-C₄ hydroxyalkyl and —(C₂H₄O)ₓH, where x is in the range of from 1 to 3. The ether component here may be derived from ethylene oxide units, propylene oxide units, 1,2-butylene oxide units, 1,4-butylene oxide units and random copolymers and block copolymers thereof.

(viii) Rhamnolipids

In another embodiment, the nonionic surfactants b) are selected from rhamnolipids. Rhamnolipids are a class of glycolipids having a rhamnose moiety as glycosyl head group and a 3-(hydroxyalkanoyloxy)alkanoic acid (HAA) fatty acid tail, such as 3-hydroxydecanoic acid. They are produced from bacteria, like Pseudomonas aeruginosa and are also denoted as bacterial surfactants. Specifically, there are two main classes of rhamnolipids, mono-rhamnolipids and di-rhamnolipids, which consist of one or two rhamnose groups respectively.

### (ix) Sophorolipids

In another embodiment, the nonionic surfactants b) are selected from sophoroolipids. Sophorolipids are glycolipids that consist of a hydrophobic fatty acid tail of 16 or 18 carbon atoms and sophorose as hydrophilic carbohydrate head, a glucose-derived di-saccharide with a β-1,2 bond that can be acetylated in the 6′- and/or the 6″-positions. One terminal or sub terminal hydroxylated fatty acid is β-glycosidically linked to the sophorose module. The carboxylic end of this fatty acid is either free (acidic or open form) or internally esterified at the 4″ position or at the 6′-position or 6″-position (lactonic form).

In a preferred embodiment, component b) comprises or consists of at least one low foaming surfactant.

Low foaming nonionic surfactants and methods for the determination of the foaming properties of a nonionic surfactant are in principle known to a person skilled in the art. Foaming power and antifoaming power of a surfactant can be determined by the turbine stirring method according to DIN EN 13996:2003-01. A further method suitable for measuring the foamability of a surfactant and the stability of the foam produced, which is based on height measurement is the Ross-Miles method or the method according to ASTM D 1173 based on the Ross-Miles method. For simulation of industrial conditions, e.g. in a dishwashing machine, a Glewwe foam meter can be used that provides a dynamic foam test rather than a static test (as in the case of the Ross-Miles foam test). The equipment and general procedure for the Glewwe form test is described in U.S. Pat. No. 3,899,387, column 12, line 45 et seq. Further details regarding the Glewwe foam test are shown in U.S. Pat. No. 5,447,648. Both references are herein incorporated by reference in its entirety.

Nonionic surfactant solutions tend to cloud when the temperature rises. The water molecules bonded to the ether oxygen of the polyoxyalkylene groups separate as the temperature rises (dehydration) and the solubility against water decreases, causing a liquid-liquid detachment that makes the liquid cloud. The cloud point is the temperature at which a nonionic surfactants become separated from the solution. Below the cloud point, the surfactant shows higher foaming and above the cloud point, the foaming decreases dramatically.

Preferably, component b) comprises or consists of at least one low foaming nonionic surfactant, in particular component b) comprises or consists of at least one nonionic surfactant having a cloud point of 60° C. or less, preferably 50° C. or les, in particular 40° C. or less.

The nonionic surfactants from the afore-mentioned classes (i) and (ii) are generally suitable as low foaming nonionic surfactants.

The rinse aid composition according to the invention preferably comprises from 0.5 to 89.9995% by weight, more preferably from 1.0 to 74,9995% by weight, in particular from 2.0 to 59,9995% by weight, especially from 2.5 to 25% by weight, more especially from 2.5 to 20% by weight, based on the total weight of the composition, of at least one nonionic surfactant (component b)).

### Water (Component c)

In a preferred embodiment, the rinse aid composition is a liquid (aqueous) formulation that comprises water as solvent.

The rinse aid according to any of the preceding claims, preferably comprises from 10 to 95% by weight, more preferably from 25 to 90% by weight, in particular from 40 to 85% by weight, based on the total weight of the composition, water (component c)).

### Additional Components:

The rinse aid composition according to the invention can comprise at least one additional component, selected from functional additives (component d)), organic solvents and mixtures thereof. The term functional additive is broadly understood to include any component that imparts a desired property to the composition, be it in terms of its direct use as a rinse aid, the way it is formulated, but also aesthetic aspects, etc. In the sense of this application solvents, be it organic solvents or water, are not regarded as functional additives d). Some particular examples of functional additives are described in more detail below, however the particular components discussed are given by way of example only, and a broad variety of other functional additives d) may be used.

In one embodiment, the rinse aid composition consists only of the structural polypeptide a) and the nonionic surfactant b).

In another embodiment, the rinse aid consists only of the structural polypeptide a), the nonionic surfactant b) and water c).

In another embodiment, the structural polypeptide a), the nonionic surfactant b) and, if present, water c) make up a large amount of the composition, preferably at least 50% by weight, more preferably at least 75% by weight, in particular, at least 90% by weight, based on the total weight of the rinse aid composition. In another embodiment, at least one additional component may be included in the rinse aid composition to provide desired properties and functionalities to the composition.

In a preferred embodiment, the rinse aid composition according to the invention comprises at least one additional component, selected from functional additives (component d)), organic solvents and mixtures thereof.

### Functional Additives (Component d))

Preferably, the at least one functional additive is selected from surfactants different from component b), builders, hydrotropes, defoamers, pH controlling agents, further additives and mixtures thereof.

In one embodiment, the rinse aid composition does not contain any further additive different from additional surfactants (different from component b)), builders, hydrotropes, defoamers, pH controlling agents, and mixtures thereof. In another embodiment, the rinse aid composition comprises at least one further additive. Further additives are preferably selected from bleaches, enzymes, optical brighteners, antiredeposition agents, antimicrobial agents, antioxidants, rheology modifiers, solubility modifiers, stabilizing agents, corrosion inhibitors, dyes, fragrances, fillers, tableting aids, disintegrants, humectants, electrolytes, water conditioning agents and mixtures thereof.

In one embodiment, the rinse aid comprises a total amount of functional additives from 0 to 50% by weight, especially from 0 to 25% by weight, more especially from 1 to 10% by weight, based on the total weight of the composition. If the rinse aid comprises at least one functional additive, then the total amount of functional additives is at least 0.1% by weight, more preferably at least 0.5% by weight, in particular at least 1.0% by weight, based on the total weight of the composition. In some embodiments, the rinse composition includes from 0.1 to 50% by weight of functional additives, especially from 0.1 to 25% by weight of functional additives, more especially from 0.5 to 10% by weight of functional additives, in each case based on the total weight of the composition.

In a preferred embodiment, the rinse aid composition comprises no added (extraneous) organic solvents. In a further preferred embodiment, the rinse aid composition comprises from 0.1 to 25% by weight, preferably from 0.1 to 10% by weight, in particular from 0.2 to 5% by weight, based on the total weight of the composition, of at least one organic solvent.

Preferred organic solvents are partly or fully water-miscible organic solvents. Suitable organic solvents are selected from mono- or polyhydric alcohols, alkanolamines, glycol ethers and mixtures thereof. The organic solvents are preferably selected from ethanol, n-propanol, isopropanol, 1-butanol, 2-butanol, tert-butanol, isobutanol, glycol, propanediol, butanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether or dipropylene glycol monoethyl ether, diisopropylene glycol monomethyl ether, diisopropylene glycol monoethyl ether, methoxytriglycol, ethoxytriglycol, butoxytriglycol, butoxyethoxy-2-propanol, 3-methyl-3-methoxybutanol, propylene glycol tert-butyl ether and mixtures of these solvents.

### Additional Surfactants

The rinse aid composition may contain at least one surfactant different from component b). Suitable surfactants d) are generally anionic surfactants, cationic surfactants, amphoteric surfactants and mixtures thereof.

It has been found that the combination of at least one structural polypeptide a) and at least one nonionic surfactant b) allows the formulation of rinse aids with superior application properties. Compositions of the invention based exclusively on nonionic surfactants are generally suitable for use in rinse aid compositions providing good sheeting, wetting and drying properties. In a special embodiment, the rinse aid composition according to the invention comprises exclusively nonionic surfactants.

To provide additional detersive properties and functionalities to the compositions, at least on surfactant different from component b) may be employed. Suitable anionic surfactants are soaps, alkylsulfonates, alkylbenzenesulfonates, olefinsulfonates, methyl ester sulfonates, sulfo fatty acids, alkyl sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids, for example acyl lactylates, acyl tartrates, acyl glutamates and acyl aspartates, alkyl oligoglucoside sulfates, alkylglucose carboxylates, protein fatty acid condensates and alkyl (ether) phosphates.

Suitable anionic surfactants are also surfactants containing polyether groups, preferably selected from alkyl polyether sulfates, aryl polyether sulfates, alkylaryl polyether sulfates, alkyl polyether sulfonates, aryl polyether sulfonates, alkylaryl polyether sulfonates, alkyl polyether phosphates, aryl polyether phosphates, alkylaryl polyether phosphates, glyceryl ether sulfonates, glyceryl ether sulfates, monoglyceride (ether) sulfates, fatty acid amide ether sulfates and mixtures thereof.

Suitable amphoteric surfactants are, for example, alkyl betaines, alkylamidopropyl betaines, alkyl sulfobetaines, alkyl glycinates, alkyl carboxyglycinates, alkyl amphoacetates or alkyl amphopropionates, alkyl amphodiacetates or alkyl amphodipropionates. For example, it is possible to use cocodimethylsulfopropyl betaine, lauryl betaine, cocamidopropyl betaine, sodium cocamphopropionate or tetradecyldimethylamine oxide.

Suitable cationic surfactants include, for example, quaternized ammonium compounds, especially alkyltrimethylammonium and dialkyldimethylammonium halides and alkylsulfates, and also pyridine and imidazoline derivatives, especially alkylpyridinium halides. For example, it is possible to use behenyl- or cetyltrimethylammonium chloride.

### Builder

The rinse aid composition according to the invention may comprises at least one builder as functional additive d).

In the terms of the invention, the term builder also encompasses cobuilder. Builders, which are inter alia also referred to as sequestrants, sequestrating agents, builder materials, complexing agents, chelators, chelating agents, softeners or crystal growth inhibitors, bind alkaline earth metals and other water-soluble metal salts and avoid precipitation of solid crystals on the surfaces of the washed items and the dishwasher. When used in a rinse aid they in particular disperse soil components not removed during the wash cycles and help to avoid a redeposition on the cleaned ware.

The rinse aid composition according to the invention preferably comprises, based on the total weight of the composition, up to 50% by weight, more preferably up to 25% by weight, in particular up to 10% by weight, of at least one builder. In a special embodiment, the rinse aid composition comprises from 0.1 to 50% by weight, more preferably from 0.5 to 25% by weight, in particular from 1 to 10% by weight, of at least one builder.

Suitable builders are in principle all classes of organic builders. Examples of suitable classes of builders are polycarboxylic acids and salts thereof, hydroxycarboxylic acids and salts thereof, phosphonic acids and salts thereof, e.g. hydroxyalkylphosphonic acids and salts thereof, aminopolycarboxylic acids and salts thereof, polymeric compounds containing carboxylic acid groups and salts thereof, polymeric compounds containing sulfonic acid groups and salts thereof, phosphates and polyphosphates, and mixtures thereof.

Suitable builders are, for example, C₄-C₃₀-di-, -tri- and -tetracarboxylic acids, for example succinic acid, propanetricarboxylic acid, butanetetracarboxylic acid, cyclopentanetetracarboxylic acid, and alkyl- and alkenylsuccinic acids having C₂-C₂₀-alkyl or -alkenyl radicals.

Suitable builders are also hydroxycarboxylic acids and polyhydroxycarboxylic acids (sugar acids). These include C₄-C₂₀-hydroxycarboxylic acids, for example malic acid, tartaric acid, gluconic acid, mucic acid, lactic acid, glutaric acid, citric acid, tartronic acid, glucoheptonic acid, lactobionic acid, and sucrosemono-, -di- and tricarboxylic acid. Preferred is citric acid and salts thereof. A preferred salt is sodium citrate.

Suitable builders are further phosphonic acids, for example hydroxyalkylphosphonic acids, aminophosphonic acids and the salts thereof. These include, for example, phosphonobutanetricarboxylic acid, aminotris(methylenephosphonic acid) (ATMP), ethylenediamine tetramethylenephosphonic acid (EDTMP), hexamethylenediamine tetramethylenephosphonic acid (HDTMP), diethylenetriamine-pentamethylenephosphonic acid (DTPMP), morpholinomethanediphosphonic acid, 1-hydroxyethane-1,1-diphosphonic acid (HEDP) and mixtures thereof. Preferred is 1-hydroxyethane-1,1-diphosphonic acid and salts thereof.

Suitable builders are further aminopolycarboxylic acids, such as nitrilotriacetic acid (NTA), nitrilomonoacetic dipropionic acid, nitrilotripropionic acid, β-alaninediacetic acid (β-ADA), ethylenediaminetetraacetic acid (EDTA), diethylenetriaminepentaacetic acid, 1,3-propylenediaminetetraacetic acid, 1,2-propylenediaminetetraacetic acid, N-(alkyl)ethylenediaminetriacetic acid, N (hydroxyalkyl)ethylenediaminetriacetic acid, ethylenediaminetriacetic acid, cyclohexylene-1,2-diaminetetraacetic acid, iminodisuccinic acid, ethylenediaminedisuccinic acid, serinediacetic acid, isoserinediacetic acid, L-asparaginediacetic acid, L-glutaminediacetic acid (GLDA), methylglycinediacetic acid (MGDA), and the salts of the aforementioned aminopolycarboxylic acids, and mixtures thereof. Preferred are ethylenediaminetetraacetic acid (EDTA) and salts thereof, L-glutaminediacetic acid (GLDA) and salts thereof, methylglycinediacetic acid (MGDA) and salts thereof, and mixtures thereof.

Suitable builders are further polymeric compounds containing carboxylic acid groups. An example are acrylic acid homo- and copolymers and the salts thereof. Acrylic acid homopolymers preferably have a number-average molecular weight in the range from 800 to 70 000 g/mol, more preferably from 900 to 50 000 g/mol, particularly from 1000 to 20 000 g/mol, especially 1000 to 10 000 g/mol. The term “acrylic acid homopolymer” also comprises polymers in which some or all of the carboxylic acid groups are in neutralized form. These include acrylic acid homopolymers in which some or all of the carboxylic acid groups are in the form of alkali metal salts or ammonium salts. Preference is given to acrylic acid homopolymers in which the carboxylic acid groups are protonated or in which some or all of the carboxylic acid groups are in the form of sodium salts.

Suitable builders are further oligomaleic acids and the salts thereof.

Suitable builders are further terpolymers of unsaturated C₄-C₈-dicarboxylic acids, where the polymerized comonomers may include monoethylenically unsaturated monomers from group (i) specified below in amounts of up to 95% by weight, from group (ii) in amounts of up to 60% by weight and from group (iii) in amounts of up to 20% by weight. Suitable unsaturated C₄-C₈-dicarboxylic acids in this context are, for example, maleic acid, fumaric acid, itaconic acid and citraconic acid. Group (i) comprises monoethylenically unsaturated C₃-C₈-monocarboxylic acids, for example acrylic acid, methacrylic acid, crotonic acid and vinylacetic acid. From group (i), preference is given to using acrylic acid and methacrylic acid. Group (ii) comprises monoethylenically unsaturated C₂-C₂₂-olefins, vinyl alkyl ethers having C₁-C₈-alkyl groups, styrene, vinyl esters of C₁-C₈-carboxylic acids, (meth)acrylamide and vinylpyrrolidone. From group (ii), preference is given to using C₂-C₆-olefins, vinyl alkyl ethers having C₁-C₄-alkyl groups, vinyl acetate and vinyl propionate. If the polymers of group (ii) comprise vinyl esters in polymerized form, they may also be present partly or fully hydrolyzed to vinyl alcohol structural units. Group (iii) comprises (meth)acrylic esters of C₁-C₆ alcohols, (meth)acrylonitrile, (meth)acrylamides of C₁-C₈ amines, N-vinylformamide and N-vinylimidazole.

Suitable builders are further homopolymers of monoethylenically unsaturated C₃-C₈-monocarboxylic acids, for example acrylic acid, methacrylic acid, crotonic acid and vinylacetic acid, especially of acrylic acid and methacrylic acid, copolymers of dicarboxylic acids, for example copolymers of maleic acid and acrylic acid in a weight ratio of 10:90 to 95:5, more preferably those in a weight ratio of from 30:70 to 90:10 with molar masses of from 1000 to 150 000; copolymers of itaconic acid and acrylic acid in a weight ratio of 10:90 to 95:5; terpolymers of maleic acid, acrylic acid and a vinyl ester of a C₁-C₃-carboxylic acid in a weight ratio of from 10 (maleic acid):90 (acrylic acid+vinyl ester) to 95 (maleic acid):10 (acrylic acid+vinyl ester), where the weight ratio of acrylic acid to the vinyl ester may vary within the range from 30:70 to 70:30; copolymers of maleic acid with C₂-C₈-olefins in a molar ratio of from 40:60 to 80:20, particular preference being given to copolymers of maleic acid with ethylene, propylene or isobutene in a molar ratio of 50:50.

Suitable builders are further sulfonated copolymers, comprising in copolymerized form at least one monoethylenically unsaturated monomer having a sulfonic acid group and/or a salt thereof and at least one ethylenically unsaturated comonomer. The ethylenically unsaturated comonomer is preferably selected from monoethylenically unsaturated monocarboxylic acids and the salts thereof, monoethylenically unsaturated dicarboxylic acids and the anhydrides and salts thereof and further ethylenically unsaturated monomers copolymerizable therewith. Suitable salts of the aforementioned acid monomers are e.g. the sodium, potassium or ammonium salts.

Suitable monoethylenically unsaturated monomers having a sulfonic acid group are 2-acrylamido-2-methyl-1-propane sulfonic acid (AMPS), 2-methacrylamido-2-methyl-1-propanesulfonic acid, 2-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate and salts of these acids.

Suitable monoethylenically unsaturated monocarboxylic acids are C₃-C₆-monocarboxylic acids, such as acrylic acid, methacrylic acid, ethylacrylic acid, crotonic acid, vinyl acetic acid, allyl acetic acid, the sodium, potassium or ammonium salts and mixtures thereof. Preferred are acrylic acid, methacrylic acid and the salts and mixtures thereof.

Suitable monoethylenically unsaturated dicarboxylic acids and the anhydrides and salts thereof are maleic acid, maleic anhydride, maleic acid salts, itaconic acid, itaconic anhydride, itaconic acid salts, fumaric acid, fumaric acid salts and mixtures thereof and the as well as the corresponding sodium, potassium or ammonium salts of maleic or itaconic acid. Preferred are maleic acid, maleic anhydride, itaconic acid, itaconic anhydride and the salts of maleic acid and itaconic acid.

Suitable further ethylenically unsaturated monomers are C₁-C₈-alkyl esters of (meth)acrylic acid, C₁-C₄-hydroxyalkyl esters of (meth)acrylic acid, (meth)acrylamide, N,N-di(C₁-C₄-alkyl)-substituted (meth)acrylamide, vinylphosphonic acid, vinyl acetate, vinyl propionate, allyl alcohols, sulfonated allyl alcohols, vinylaromatic monomers, (meth)acrylonitrile, N-vinylpyrrolidone, N-vinylformamide, N-vinylacetamid, N-vinylimidazole or N-vinylpyridine and mixtures thereof. Preferably, the C₁-C₈-alkyl esters of (meth)acrylic acid are selected from methyl (meth)acrylate, ethyl (meth)acrylate, n-butyl (meth)acrylate, isobutyl (meth)acrylate, tert-butyl (meth)acrylate, n-octyl (meth)acrylate, 2-ethylhexyl (meth)acrylate, and mixtures thereof. The C₁-C₄-hydroxyalkyl esters of (meth)acrylic acid is preferably selected from 2-hydroxy ethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, and mixtures thereof. The vinylaromatic monomer is preferably selected from styrene, alpha-methyl styrene, p-tert-butyl styrene, o- or p-vinyl toluene, and mixtures thereof.

In one embodiment, the builder comprises, in copolymerized form,
2% to 50% by weight of at least one monoethylenically unsaturated monomer having a sulfonic acid group and/or a salt thereof,
50% to 98% by weight of at least one monoethylenically unsaturated monocarboxylic acid and/or a salt thereof,
0 to 30% (e.g. 1 to 30%) by weight of at least one ethylenically unsaturated C₄-C₈-dicarboxylic acid and/or an anhydride or salt thereof,
0 to 30% (e.g. 1 to 30%) by weight of at least one further monomer which is copolymerizable with the aforementioned monomers.

The further monomers are preferably selected from C₁-C₄-alkyl esters of (meth)acrylic acid, C₁-C₄-hydroxyalkyl esters of (meth)acrylic acid, acrylamide, N-alkyl-substituted acrylamide, N,N-dialkyl-substituted acrylamide, vinylphosphonic acid, vinyl acetate, allyl alcohols, sulfonated allyl alcohols, styrene and other vinylaromatics, acrylonitrile, N-vinylpyrrolidone, N-vinylformamide, N-vinylimidazole or N-vinylpyridine. The weight-average molecular weight of these copolymers is within the range from 3000 to 50 000 daltons.

In another embodiment, the builder comprises, in copolymerized form,
5 to 15% by weight of at least one monoethylenically unsaturated monomer having a sulfonic acid group and/or a salt thereof,
30 to 60% by weight of at least one monoethylenically unsaturated monocarboxylic acid and/or a salt thereof,
30 to 60% by weight of at least one ethylenically unsaturated C₄-C₈-dicarboxylic acid and/or an anhydride or salt thereof,
0 to 30% (e.g. 1 to 30%) by weight of at least one further monomer which is copolymerizable with the afore-mentioned monomers.

Preferably, said copolymer has a weight average molecular weight of from about 1000 to about 50000.

In another embodiment, the builder is selected from the sulfonated polymers described in WO 2010/067054 A1.

A preferred embodiment are copolymers of at least one ethylenically unsaturated C₃-C₆-monocarboxylic acid and at least one ethylenically unsaturated sulfonic acid, in particular copolymers of acrylic acid and 2-acrylamido-2-methyl-1-propane sulfonic acid (AMPS) (commercially available under the tradename ACUSOL 588 from Dow Chemical Company). Particularly suitable copolymers are those with about 77% by weight of at least one ethylenically unsaturated C₃-C₆-monocarboxylic acid and about 23% by weight of at least one ethylenically unsaturated sulfonic acid.

Suitable organic builders are further graft polymers of unsaturated carboxylic acids onto low molecular weight carbohydrates or hydrogenated carbohydrates. Suitable unsaturated carboxylic acids in this context are, for example, maleic acid, fumaric acid, itaconic acid, citraconic acid, acrylic acid, methacrylic acid, crotonic acid and vinylacetic acid and also mixtures of acrylic acid and maleic acid, which are grafted on in amounts of 40% to 95% by weight, based on the component to be grafted. It is possible to use up to 30% by weight, based on the component to be grafted, of further monoethylenically unsaturated monomers. Suitable modifying monomers are the abovementioned monomers of groups (ii) and (iii). Suitable graft bases are degraded polysaccharides, for example acidically or enzymatically degraded starches, inulins or cellulose, protein hydrolyzates and reduced (hydrogenated or hydrogenatingly aminated) degraded polysaccharides, for example mannitol, sorbitol, aminosorbitol and N-alkylglucamine, as are polyalkylene glycols with molar masses of up to Mw=5000, for example polyethylene glycols, ethylene oxide/propylene oxide or ethylene oxide/butylene oxide or ethylene oxide/propylene oxide/butylene oxide block copolymers and alkoxylated mono- or polyhydric C₁-C₂₂ alcohols.

Suitable organic builders are further polyglyoxylic acids.

Suitable organic builders are further polyamidocarboxylic acids and modified polyamidocarboxylic acids.

Suitable organic builders are further polyaspartic acids or cocondensates of aspartic acid with further amino acids, C₄-C₂₅ mono- or -dicarboxylic acids and/or C₄-C₂₅ mono- or -diamines. A special embodiment are polyaspartic acids which have been prepared in phosphorus acids and have been modified with C₆-C₂₂ mono- or -dicarboxylic acids or with C₆-C₂₂ mono- or -diamines.

A preferred class of builders are polymeric compounds containing carboxylic acid groups. In particular preferred as builders are polyacrylic acid homo and copolymers that can be in partly or fully neutralized form.

Suitable organic builders are further iminodisuccinic acid, oxydisuccinic acid, aminopolycarboxylates, alkyl polyaminocarboxylates, aminopolyalkylenephosphonates, polyglutamates, hydrophobically modified citric acid, for example agaric acid, poly-α-hydroxyacrylic acid, N-acylethylenediamine triacetates such as lauroylethylenediamine triacetate and alkylamides of ethylenediaminetetraacetic acid, such as EDTA tallow amide.

In a special embodiment, the rinse aid composition comprises a builder b) selected from methyl glycine diacetic acid (MGDA) and the salts thereof, glutamic-N,N-diacetic acid (GLDA) and the salts thereof, iminodisuccinic acid and the salts thereof, ethylenediaminetetraacetic acid (EDTA) and the salts thereof, diethylene triamine pentaacetic acid (DTPA) and the salts thereof, hydroxyethyl ethylene diamine triacetic acid (HEDTA) and the salts thereof, carboxy methyl inulin and the salts thereof, and mixtures of the afore-mentioned builders.

In a special embodiment, a mixture of different builders is used. The mixture of different builders preferably comprises at least two of the following constituents:
at least one polymeric compound containing carboxylic acid groups or a partly or fully neutralized form thereof (preferably polyacrylic acid or a partly or fully neutralized form thereof),
at least one (poly)hydroxycarboxylic acid or a salt thereof (preferably citric acid or a citrate, in particular sodium citrate),
at least one aminopolycarboxylic acid or a salt thereof, preferably selected from methylglycinediacetic acid (MGDA) and salts thereof, ethylenediaminetetraacetic acid (EDTA) and salts thereof and L-glutaminediacetic acid (GLDA) and salts thereof,
   at least one hydroxyalkylphosphonic acid or aminophosphonic acid, preferably 1-hydroxyethane-1-(1,1-diphosphonic acid) (HEDP),
   at least one sulfonated copolymer and/or a salts thereof.

In one preferred embodiment, the rinse aid composition comprises at least one polymeric builder, preferably selected from sulfonated copolymers and the salts thereof. Preferred are AMPS copolymers.

In another preferred embodiment, the rinse aid composition comprises at least one builder, selected from hydroxycarboxylic acids, salts of hydroxycarboxylic acids, polyhydroxycarboxylic acids (sugar acids), salts of polyhydroxycarboxylic acids and mixtures thereof. Preferred is citric acid and salts thereof. A preferred salt is sodium citrate. Those components may function as builder and pH adjusting component.

### Hydrotropes

Hydrotropes are components that function as viscosity controlling agents, gel suppressants, stability agents and/or dispersability aids. Commonly used hydrotropes include alcohols and alcohol derivatives, including glycols and alkoxylated alcohols. Suitable hydrotropes for use herein also include anionic type hydrotropes, particularly sodium, potassium and ammonium xylene sulfonate, sodium, potassium and ammonium toluene sulfonate, sodium, potassium and ammonium cumene sulfonate, dialkyl sulfosuccinates, alkyl naphthalene sulfonates and mixtures thereof. Dialkyl sulfosuccinates and alkyl naphthalene sulfonates have been mentioned before as anionic surfactants. Especially, the hydrotopes are selected from sodium cumene sulfonate, sodium xylene sulfonate, sodium toluene sulfonate, dihexyl sodium sulfosuccinate, dioctyl sodium sulfosuccinate, alkyl naphthalene sulfonates and mixtures thereof.

The rinse aid of the invention preferably comprises from 0 to 15% by weight, more preferably from 0% to 12% by weight, in particular from 0% to 10% by weight, based on the total weight of the composition, of at least one hydrotrope. If the rinse aid comprises at least one hydrotope, then the amount is at least 0.1% by weight, more preferably at least 0.5% by weight, in particular at least 1.0% by weight, based on the total weight of the composition.

### Defoamers/Foam Inhibitors/Suds Suppressors

It has been found that the combination of at least one structural polypeptide a) and at least one nonionic surfactant b) allows the formulation of rinse aids with low foaming properties also without the use of additional defoaming components. In particular, if the nonionic surfactant b) comprises or consists of one of the afore-mentioned low foaming nonionic surfactants, the use of an additional defoamer can usually be dispensed with.

In a special embodiment, the rinse aid composition according to the invention comprises no additional defoamers apart from the nonionic surfactants b).

In another embodiments, the rinse aid composition comprises at most 10% by weight, more preferably at most 5% by weight, in particular at most 1% by weight, especially at most 0.1% by weight of at least one defoamer. Preferably, if a defoaming agents is desirable, the rinse aid may contain at least one nonionic EO containing surfactant b) that is hydrophilic and water soluble at relatively low temperatures, in particular temperatures below the temperatures at which the rinse aid will be used.

Suitable as defoamers are phosphate ester defoamers, in particular alkyl phosphate esters containing from 16 to 20 carbon atoms. Such phosphate ester defoamers may be monostearyl acid phosphate or monooleyl acid phosphate or salts thereof, preferably alkali metal salts. Suitable as defoamers are also silicone defoamers.

### pH Controlling Agents

The rinse aid composition may contain at least one pH controlling agent to adjust the pH value of the composition and/or the pH value of the resulting rinse liquid under the use conditions of the composition. In one embodiment, the rinse aid composition comprises at least one pH controlling agent, selected from acids, bases and pH buffer systems. The rinse aid composition can be formulated such that during use, for example in an aqueous liquid in a dishwashing process, the rinse liquid will have a desired pH value. For example, the rinse aid composition may be formulated such that during use (e.g. in the rinse cycle of a dishwasher) the rinse liquid will have a pH in the range of 11.0 or below, more preferably, 10.0 or below, in particular 9.0 or below, especially, 8.5 or below. In another embodiment, the pH value of the rinse liquid is in a range of 3 to 9, more preferably 5 to 8.5. Techniques for controlling the pH value at recommended usage levels, including the use of acids, bases, buffers, etc. are well known to those skilled in the art.

Aqueous rinse aid compositions according to the invention in one embodiment, in particular for I&I applications, have a pH value in the range of about 2 to about 4. In another embodiment, in particular for consumer applications, the aqueous rinse aid composition has a pH value in the range of 4 to 9.

Suitable bases (also denoted as alkalinity sources or alkalinity reserve) are alkali metal hydroxides, alkaline earth metal hydroxides, alkali metal carbonates, alkaline earth metal carbonates, ammonium carbonate, alkali metal hydrogencarbonates, alkaline earth metal hydrogen carbonates, ammonium hydrogencarbonate, alkali metal silicates and mixtures thereof.

Suitable acids are carboxylic acids, hydroxycarboxylic acids and phosphoric acid. Preferably the acid is selected from citric acid, gluconic acid, tartaric acid, glucoheptonic acid, mucic acid, galactonic acid, saccharic acid, fumaric acid, succinic acid, glutaric acid, adipic acid and phosphoric acid. Particularly preferred is citric acid.

### Bleaches

The rinse aid composition according to the invention may comprises at least one bleach as functional additive d).

In the sense of the present application, the term bleach denotes also bleach systems that possibly also comprise bleach activators, bleach catalysts and/or bleach stabilizers.

The rinse aid composition according to the invention preferably comprises from 0 to 30% by weight, more preferably from 0 to 25% by weight, based on the total weight of the composition, of at least one bleach (component d)). If the rinse aid composition comprises at least one bleach, then the amount is at least from 0.5% by weight, more preferably at least 1% by weight, based on the total weight of the composition. If the bleach comprises more than one component, the aforementioned amounts refer to the sum of all components of the bleach system.

Suitable bleaches are, for example, percarboxylic acids, for example diperoxododecanedicarboxylic acid, phthalimidopercaproic acid or monoperoxophthalic acid or -terephthalic acid, salts of percarboxylic acids, for example sodium percarbonate, adducts of hydrogen peroxide onto inorganic salts, for example sodium perborate monohydrate, sodium perborate tetrahydrate, sodium carbonate perhydrate or sodium phosphate perhydrate, adducts of hydrogen peroxide onto organic compounds, for example urea perhydrate, or of inorganic peroxo salts, for example alkali metal persulfates or peroxodisulfates.

Suitable bleach activators are, for example, polyacylated sugars, e.g. pentaacetylglucose; acyloxybenzenesulfonic acids and their alkali metal and alkaline earth metal salts, e.g. sodium p-nonanoyloxybenzenesulfonate or sodium p-benzoyloxybenzenesulfonate; N,N-diacylated and N,N,N′,Ni-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins such as 1,3-diacetyl-5,5-dimethylhydantoin; N-alkyl-N-sulfonylcarbonamides, e.g. N-methyl-N-mesylacetamide or N-methyl-N-mesylbenzamide; N-acylated cyclic hydrazides, acylated triazoles or urazoles, e.g. monoacetylmaleic hydrazide; O,N,N-trisubstituted hydroxylamines, e.g. O-benzoyl-N,N-succinylhydroxylamine, O-acetyl-N,N-succinylhydroxylamine or O,N,N-triacetylhydroxylamine; N,N′-diacylsulfurylamides, e.g. N,N′-dimethyl-N,N′-diacetylsulfurylamide or N,N′-diethyl-N,N′-dipropionylsulfurylamide; acylated lactams, for example acetylcaprolactam, octanoylcaprolactam, benzoylcaprolactam or carbonylbiscaprolactam; anthranil derivatives, for example 2-methylanthranil or 2-phenylanthranil; triacyl cyanurates, e.g. triacetyl cyanurate or tribenzoyl cyanurate; oxime esters and bisoxime esters, for example O-acetylacetone oxime or bisisopropyl iminocarbonate; carboxylic anhydrides, e.g. acetic anhydride, benzoic anhydride, m-chlorobenzoic anhydride or phthalic anhydride; enol esters, for example isopropenyl acetate; 1,3-diacyl-4,5-diacyloxyimidazolines, e.g. 1,3-diacetyl-4,5-diacetoxyimidazoline; tetraacetylglycoluril and tetrapropionylglycoluril; diacylated 2,5-diketopiperazines, e.g. 1,4-diacetyl-2,5-diketopiperazine; ammonium-substituted nitriles, for example N-methylmorpholinioacetonitrile methylsulfate; acylation products of propylenediurea and 2,2-dimethylpropylenediurea, e.g. tetraacetylpropylenediurea; α-acyloxypolyacylmalonamides, e.g. α-acetoxy-N,N′-diacetylmalonamide; diacyldioxohexahydro-1,3,5-triazines, e.g. 1,5-diacetyl-2,4-dioxohexahydro-1,3,5-triazine; benz-(4H)-1,3-oxazin-4-ones with alkyl radicals, e.g. methyl, or aromatic radicals, e.g. phenyl, in the 2 position.

A bleach system composed of bleaches and bleach activators may optionally also comprise bleach catalysts. Suitable bleach catalysts are, for example, quaternized imines and sulfonimines, described, for example, in U.S. Pat. No. 5,360,569 and EP-A-453003. Particularly effective bleach catalysts are manganese complexes, described, for example, in WO 94/21777. In addition to the described bleach system composed of bleaches, bleach activators and optionally bleach catalysts, it is also possible to use systems with enzymatic peroxide release.

### Enzymes

The rinse aid composition according to the invention may comprise at least one enzyme.

The rinse aid composition according to the invention preferably comprises at least one enzyme in an amount of from 0 to 10% by weight, more preferably from 0 to 8% by weight, in particular from 0 to 5% by weight, enzyme protein based on the total weight of the composition.

If the rinse aid composition comprises at least one enzyme, the amount of enzyme protein is preferably at least 0.001% by weight, more preferably at least 0.01% by weight, in particular at least 0.05% by weight, based on the total weight of the composition.

Often, enzymes are employed in dishwashing formulations not in form of the pure active enzyme protein but in combination with a carrier and/or in encapsulated form and optionally with further additives. The afore-mentioned amounts refer to the active enzyme protein without any further components.

The enzymes are preferably selected from aminopeptidases, amylases, arabinases, carbohydrases, carboxypeptidases, catalases, cellulases, chitinases, cutinases, cyclodextrin glycosyltransferases, deoxyribonucleases, esterases, galactanases, alpha-galactosidases, beta-galactosidases, glucanases, glucoamylases, alpha-glucosidases, beta-glucosidases, haloperoxidases, hydrolases, invertases, isomerases, keratinases, laccases, lipases, mannanases, mannosidases, oxidases, pectinolytic enzymes, peptidoglutaminases, peroxidases, peroxygenases, phytases, polyphenol oxidases, proteolytic enzymes, ribonucleases, transglutaminases, transferases, xylanases and mixtures thereof.

In particular, the rinse aid composition comprises one or more enzymes selected from amylases, arabinases, carbohydrases, cellulases (e.g. endoglucanases), cutinases, deoxyribonucleases, galactanases, haloperoxygenases, lipases, mannanases, oxidases (e.g. laccases and/or peroxidases), pectinases, pectin lyases, proteases, xylanases, xanthanases, xyloglucanases, oxidoreductase and mixtures thereof. Preferably, the rinse aid composition comprises at least one enzyme selected from amylases, arabinases, carbohydrases, cellulases, galactanases, lipases, mannanases, pectinases, pectin lyases, proteases and mixtures thereof.

In a special embodiment, the rinse aid composition comprises at least one amylase. When the composition comprises at least one amylase and at least one additional enzyme, the additional enzyme is preferably a protease and/or a lipase.

### Anti-Redeposition Agents

In one embodiment, the rinse aid composition can comprise at least one anti-redeposition agent capable of facilitating sustained suspension of soils in the rinse solution and preventing removed soils from being redeposited onto the substrate being rinsed. Examples of suitable anti-redeposition agents are fatty acid amides, fluorocarbon surfactants, complex phosphate esters, styrene maleic anhydride copolymers and cellulosic derivatives such as hydroxyethyl cellulose, hydroxypropyl cellulose, etc.

The rinse aid composition according to the invention preferably comprises at least one anti-redeposition agent in an amount of from 0 to 10% by weight, more preferably from 0 to 8% by weight, in particular from 0 to 5% by weight, based on the total weight of the composition.

### Antimicrobial Agents

In one embodiment, the rinse aid composition can comprise at least one antimicrobial (sanitizing) agent. The combination of at least one structural polypeptide a) and at least one nonionic surfactant b) is suitable for providing 2-in-1 sanitizing rinse compositions with an antimicrobial efficacy against a broad spectrum of microorganisms. Suitable antimicrobial agents are in particular quaternary ammonium compounds. Quaternary ammonium compounds and their use in rinse aid formulations are described in US2022386598. Preferably, the antimicrobial quaternary ammonium compound is selected from C₁₂-C₁₆ alkyl dimethyl benzyl ammonium chloride, didecyl dimethyl ammonium chloride, dioctyl dimethyl ammonium chloride, octyl decyl dimethyl ammonium chloride, or a combination thereof. Further examples of quaternary ammonium compounds are benzethonium chloride, ethylbenzyl alkonium chloride, myristyl trimethyl ammonium chloride, methyl benzethonium chloride, cetalkonium chloride, cetrimonium bromide (CTAB), carnitine, dofanium chloride, tetraethyl ammonium bromide (TEAB), domiphen bromide, benzododecinium bromide, benzoxonium chloride, choline, cocamidopropyl betaine (CAPB), denatonium, and mixtures thereof. Said antimicrobial agents provide a broad-spectrum activity against wide range of different types of microorganisms (including both aerobic and anaerobic microorganisms, gram positive and gram negative microorganisms), including bacteria, yeasts, molds, fungi, algae, and other problematic microorganisms. The amount of quaternary ammonium compounds in a use solution is preferably in a range of 1 wt.-ppm to 10000 wt.-ppm, more preferably 1 wt.-ppm to 1000 wt.-ppm, in particular 5 wt.-ppm to 400 wt.-ppm. Concentrated compositions generally comprise at least one antimicrobial agent in an amount of 0.1 to 75 weight %, preferably, 1 to 70 weight %.

### Humectants

In one embodiment, the rinse aid composition can comprise at least one humectant. A humectant is a substance having an affinity for water. The use of humectants can be advantageous to aid in reducing the visibility of a film on the substrate surface of the ware. This can be a particular concern, when the rinse water contains a certain amount of dissolved solids. Generally, the combination of at least one structural polypeptide a) and at least one nonionic surfactant b) provides superior rinse properties so that for usual rinse aid applications, e.g. in household and industrial dishwashers, the use of humectants can be dispensed with.

In some embodiments, the rinse aid composition can include dyes, odorants including perfumes, and other aesthetic enhancing agents.

In a special embodiment, the rinse aid composition according to the invention comprises or consists of
a) at least one structural polypeptide,
b) at least one nonionic surfactant,
c) water,
d1) at least one builder, preferably selected from
   citric acid and citric acid salts,
   sulfonated copolymer and the salts thereof, and
   mixtures thereof,
d2) optionally at least one hydrotrope.

In all aspects/embodiments described above, the structural polypeptide, specifically the silk polypeptide, is preferably present in gel, particularly hydrogel, form in the rinse aid composition.

Various modifications and variations of the invention will be apparent to those skilled in the art without departing from the scope of invention. Although the invention has been described in connection with specific preferred embodiments, it should be understood that the invention as claimed should not be unduly limited to such specific embodiments. Indeed, various modifications of the described modes for carrying out the invention which are obvious to those skilled in the art in the relevant fields are intended to be covered by the present invention.

### PREFERRED EMBODIMENTS OF THE INVENTION

1. A rinse aid composition, comprising:
a) a structural polypeptide, and
b) at least one nonionic surfactant.

2. The rinse aid composition according to embodiment 1, wherein the structural polypeptide a) is a silk polypeptide.

3. The rinse aid composition according to embodiment 2, wherein the silk polypeptide is a recombinant or synthetic silk polypeptide, preferably a spider silk polypeptide.

4. The rinse aid composition according to embodiment 2 or 3, wherein the silk polypeptide
comprises or consists of a protein chain that does not have at least two units of the same sequence motifs (a single unit of amino acids), or
comprises or consists of at least two identical repetitive units.

5. The rinse aid composition according to any of embodiments 2 to 4, wherein the silk polypeptide is free of non-repetitive units.

6. The rinse aid composition according to embodiment 4 or 5, wherein the single unit or the repetitive units are independently selected from the group consisting of
module C having an amino acid sequence according to SEQ ID NO: 1 or variants thereof,
module C^{Cys} having an amino acid sequence according to SEQ ID NO: 2 or variants thereof,
module C^{Lys} having an amino acid sequence according to SEQ ID NO: 3 or variants thereof.

7. The rinse aid composition according to any of embodiments 2 to 6, wherein the silk polypeptide is selected from the group consisting of (C)ₘ, (C)ₘC^{Cys}, (C)ₘC^{Lys}, C^{Cys}(C)ₘ, C^{Lys}(C)ₘ, (C^{Cys})ₘ and (C^{Lys})ₘ, wherein m is an integer of 1 to 96.

8. The rinse aid composition according to embodiment 7, wherein the silk polypeptide is selected from the group consisting of C₁, C₂, C₃, C₄, C₅, C₆, C₇, C₈, C₁₆, C₃₂, C₄₈, (C)₁C^{Cys}, (C)₂C^{Cys}, (C)₃C^{Cys}, (C)₄C^{Cys}, (C)₅C^{Cys}, (C)₆C^{Cys}, (C)₇C^{Cys}, (C)₈C^{Cys}, (C)₁₆C^{Cys}, (C)₃₂C^{Cys}, (C)₄₈C^{Cys} (C)₁C^{Lys}, (C)₂C^{Lys}, (C)₃C^{Lys}, (C)₄C^{Lys}, (C)₅C^{Lys}, (C)₆C^{Lys}, (C)₇C^{Lys}, (C)₈C^{Lys}, (C)₁₆C^{Lys}, (C)₃₂C^{Lys}, (C)₄₈C^{Lys} C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₁₆, C^{Cys}(C)₃₂, C^{Cys}(C)₄₈, C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₁₆, C^{Lys}(C)₃₂, C^{Lys}(C)₄₈, C^{Cys}₁, C^{Cys}₂, C^{Cys}₃, C^{Cys}₄, C^{Cys}₅, C^{Cys}₆, C^{Cys}₇, C^{Cys}₈, C^{Cys}₁₆, C^{Cys}₃₂, C^{Cys}₄₈, C^{Lys}₁, C^{Lys}₂, C^{Lys}₃, C^{Lys}₄, C^{LYS}₅, C^{Lys}₆, C^{Lys}₇, C^{Lys}₈, C^{Lys}₁₆, C^{Lys}₃₂ and C^{LYS}₄₈.

9. The rinse aid composition according to any of the preceding embodiments, comprising from 0.0005 to 2.5% by weight, preferably from 0.001 to 2.0% by weight, in particular from 0.005 to 1.5% by weight, based on the total weight of the composition, of at least one structural polypeptide (component a)).

10. The rinse aid composition according to any of the preceding embodiments, comprising from 0.5 to 89.9995% by weight, preferably from 1.0 to 74,9995% by weight, in particular from 2.0 to 59,9995% by weight, especially from 2.5 to 25% by weight, based on the total weight of the composition, of at least one nonionic surfactant (component b)).

11. The rinse aid composition according to any of the preceding embodiments, wherein component b) comprises or consists of at least one low foaming nonionic surfactant, in particular component b) comprises or consists of at least one nonionic surfactant having a cloud point of 60° C. or less, preferably 50° C. or less, in particular 40° C. or less.

12. The rinse aid composition according to any of the preceding embodiments, comprising from 10 to 95% by weight, preferably from 25 to 90% by weight, in particular from 40 to 85% by weight, based on the total weight of the composition, water (component c)).

13. The rinse aid composition according to any of the preceding embodiments, comprising at least one additional component, selected from functional additives (component d)), organic solvents and mixtures thereof.

14. The rinse aid composition according to embodiment 13, comprising at least one functional additive d), selected from surfactants different from component b), builders, hydrotropes, defoamers pH controlling agents, further additives and mixtures thereof.

15. The rinse aid composition according to embodiment 14, comprising at least one further additive, selected from bleaches, enzymes, optical brighteners, antiredeposition agents, antimicrobial agents, antioxidants, rheology modifiers, solubility modifiers, stabilizing agents, corrosion inhibitors, dyes, fragrances, humectants, electrolytes, water conditioning agents and mixtures thereof.

16. The rinse aid composition according to any of embodiment 13 to 15, comprising a total amount of functional additives from 0 to 50% by weight, especially from 0 to 25% by weight, more especially from 0 to 10% by weight (e.g. 0.1 to 25% by weight of functional additives or 0.5 to 10% by weight), based on the total weight of the composition.

17. The rinse aid composition according to any of embodiments 13 to 16, comprising from 0 to 25% by weight, preferably from 0.1 to 10% by weight, in particular from 0.2 to 5% by weight, based on the total weight of the composition, of at least one organic solvent.

18. The rinse aid composition according to any of the preceding embodiments, comprising at least one polymeric builder, preferably selected from sulfonated copolymers and the salts thereof.

19. The rinse aid composition according to any of the preceding embodiments, comprising at least one builder, selected from hydroxycarboxylic acids, salts of hydroxycarboxylic acids, polyhydroxycarboxylic acids, salts of polyhydroxycarboxylic acids and mixtures thereof, in particular citric acid and/or a citric acid salt.

20. The rinse aid composition according to any of the preceding embodiments, comprising:
a) at least one structural polypeptide,
b) at least one nonionic surfactant,
c) water,
d1) at least one builder, preferably selected from
   citric acid and citric acid salts,
   sulfonated copolymer and the salts thereof, and
   mixtures thereof,
d2) optionally at least one hydrotrope.

21. The rinse aid composition of any of the preceding embodiments, wherein the rinse aid composition is present in form of a gel, specifically hydrogel.

22. A method for machine cleaning of dishware, in which the dishware to be cleaned is contacted with a rinse aid composition as defined in any of embodiments 1 to 21.

23. The use of a structural polypeptide, especially a silk polypeptide, in a rinse aid composition.

24. The use according to embodiment 23, wherein the structural polypeptide is defined as in any of embodiments 2 to 21.

25. The use according to embodiment 23 or 24 for
providing good sheeting and wetting properties,
reducing spotting and filming of the dishware, in particular of glassware and cutlery,
imparting the dishware with a good shine,
preventing resoiling of the dishware,
imparting the dishware with a surface protection, in particular preventing corrosive changes of the surfaces of glassware,
the formulation of products with a low tendency of foaming,
reducing the surface tension of the dishware,
improving the drying of the dishware.

### FIGURE LEGEND

The following figures are merely illustrative of the present invention and should not be construed to limit the scope of the invention as indicated by the appended claims in any way.

FIG. 1: Shows the result of the different evaluated rinse aids on glasses. (1): Comparative examples with the commercial market leader (formulation 3, without silkgel (hydrogel)): The three glasses on the left show evident traces of streaks and spots and are more matt than the right glasses. (2): Formulation 4 according to the invention (with silkgel (hydrogel)): The three glasses on the right are very transparent, spotless and show a good shine.

FIG. 2: Shows a digital scan three cleaning cycles (A, B, C) of glass treated with IEC-D+IEC-C according to Comparative rinse aid test of Automatic Dishwashing Detergents in accordance with Fresenius Standard Method 03_2016 described above and test procedure and test conditions described previously. The results of the Digital Image Analysis were classified as follows: 5=very big spots, 4=big spots, 3=medium sized spots, 2=small spots, 1=very small spots. Medium sized spots were detected on the glass surface after the 3 consecutive washing cycles. The evaluation of spot formation was classified 3 for the glass samples treated.

FIG. 3: Shows digital scan of three cleaning cycles (A, B, C) of glass treated with IEC-D+IEC-C+silkgel according to Comparative rinse aid test of Automatic Dishwashing Detergents in accordance with Fresenius Standard Method 03_2016 described above and test procedure and test conditions described previously. The results of the Digital Image Analysis were classified as follows: 5=very big spots, 4=big spots, 3=medium sized spots, 2=small spots, 1=very small spots. Small sized spots were detected on the glass surface after the 3 consecutive washing cycles. The evaluation of spot formation were classified 2 for the glass samples treated, and therefore shows an improvement compared to glass washed with only detergent and rinse aid.

### EXAMPLES

The following examples are illustrative of the automatic dishwashing compositions of the invention. They are not intended to limit the invention described above in any way.

### Example 1

### I) Rinse Aid Formulations

### I.1) Liquid Formulations

The following liquid formulations 1 to 4 were prepared. Comparative examples 1 to 3 do not contain a structural protein (silk protein) according to the invention. Formulation 4 contains a structural protein (silk protein) according to the invention.

| | | | | Formulation 4 |
|---|---|---|---|---|
| | Comparative | Comparative | Comparative | (according to |
| Ingredient | formulation 1 | formulation 2 | formulation 3 | the invention) |
| Silk protein gel | | | | 3^{a)} wt.-% |
| containing 3 | | | | |
| wt. % silk | | | | |
| protein | | | | |
| Nonionic | 5.5 wt.-% | 6 wt.-% | 5 wt.-% | 2 wt.-% |
| surfactant (Iso- | | | | |
| C₁₃-alkyl 7EO) | | | | |
| Nonionic | 3.5 wt.-% | 9 wt.-% | 10 wt.-% | 5 wt.-% |
| surfactant (C₁₃₋₁₅ | | | | |
| alkyl 5EO | | | | |
| 2BO) | | | | |
| Sulfonated | | | 1.6 wt.-% | |
| builder | | | | |
| polymer | | | | |
| (Acusol ®588) | | | | |
| Citric acid | 3 wt.-% | | 2 wt.-% | 1 wt.-% |
| (50% aq. | | | | |
| solution) | | | | |
| Isopropanol | | 5 wt.-% | | |
| (solvent) | | | | |
| Sodium | 5 wt.-% | 8 wt.-% | 4 wt.-% | |
| cumene | | | | |
| sulfonate | | | | |
| (hydrotrope, | | | | |
| 40% aq. | | | | |
| solution) | | | | |
| Eccipients | q.s. | q.s | q.s | q.s |
| Water | q.s. ad 100% | q.s. ad 100% | q.s. ad 100% | q.s. ad 100% |

^{a)}i.e. a total content of 0.09% silk protein in the composition

### II) Application Examples

### Rinse Aid Performance

The rinse aid performance method is based on the EN 50242/EN 60436—“electric dishwashers for household use—method for measuring the performance”. The test was performed on glasses and knives

| | |
|---|---|
| Used dishware | 6x new and pre-washed clean Schott Long Drink glasses |
| | 6x new and pre-washed clean WMF knifes |
| Dishwasher type | Bosch Silence Plus |
| Washing program | “eco” |
| Washing cycles repetition | 6 |
| Water Hardness | 13° dH |
| Formulation dosage | 10 ml |
| Measurement Method | Step 1: visual assessment in black box - counting spots |
| | Step 2: v visual assessment in black box - assessing shine |
| | (filming) |

### Rating Scales:

### Step 1 (Counting Spots):

The rating depends on the number of stains (glasses an knives). The highest value for the number of spots on the dishes is >60. The greater the number of spots on glasses and knives, the poorer the effect of the rinse aid. The best rating (7) is achieved with the lowest number of spots (0-8).

| Number of spots | 0-8 | 9-16 | 17-24 | 25-32 | 33-40 | 41-49 | 50-59 | ≥60 |
|---|---|---|---|---|---|---|---|---|
| Rating | 7 | 6 | 5 | 4 | 3 | 2 | 1 | 0 |

### Step 2 (Assessing the Shine Level)

The rating depends on the shine level. Evaluation has been made only on glasses as the surface of knives is too small for assessment. The higher the score, the better the effect.

| | high matt | | | |
|---|---|---|---|---|
| Appearence | effect | medium matt | weak matt | shiny effect |
| Rating | 0 | 1 | 2 | 3 |

| Step 1: | Formulation 1 | Formulation 2 | Formulation 3 | Formulation 4 |
|---|---|---|---|---|
| spotting | (comparative) | (comparative) | (comparative) | (invention) |
| Glasses | 5 | 5 | 5 | 7 |
| Knives | 6 | 6 | 6 | 7 |

| Step 2: | Formulation 1 | Formulation 2 | Formulation 3 | Formulation 4 |
|---|---|---|---|---|
| shine | (comparative) | (comparative) | (comparative) | (invention) |
| Glasses | 1 | 2 | 2 | 3 |
| Knives | 2 | 2 | 2 | 3 |

The examples show that even with a low amount of structural protein, the rinse aid according to the invention is superior when used in the rinse cycle of a dishwashing machine. The difference between the formulation of the invention and those of the prior art is even more evident in the avoidance of spotting.

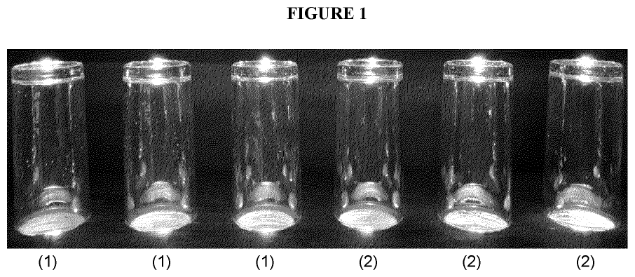

FIG. 1 shows the result of the different evaluated rinse aids on glasses.

1: Comparative Example with the Commercial Market Leader (Formulation 3):

The three glasses on the left show evident traces of streaks and spots and are more matt than the right glasses.

### 2: Formulation 4 According to the Invention:

The three glasses on the right are very transparent, spotless and show a good shine.

The examples demonstrate that the rinse aid formulations according to the invention, comprising a silk protein as structural protein, have superior spotting/filming performance.

### Example 2

### Test Method:

Comparative rinse aid test of Automatic Dishwashing Detergents in accordance to Fresenius Standard Method 03_2016.

### Test Conditions:

As washing machine, a Miele GSL 2 was used.

The program was set to 50° C., 8 min, 65° C. Rinsing Cycle.

The Hardness of water was 9±1° dH.

Dosage: 20 ppm in washing liquid

No Rinse Aid was used.

The Number of Cycles was 3 (cumulative).

### Ballast Soil:

50 g Ballast Soil per cycle were used with the ingredients: ketchup, milk, starch, fat, egg yolk, benzoic acid and water.

### Machine Loading:

Washing machine was loaded with 3 Plates Glass, black (Arcoroc), 3 Plates Porcelain, black (Schonwald), 4 Longdrink Glasses (Schott Paris 79), 4 Juice Glasses (Schott Paris 12),

### Samples Used:

IEC 60436—Typ D (Detergent, Batch number CFT-GSM D ~020 rev.2020 CFT) is referred to as IEC-D in the following and was used as a detergent.

IEC 60436—Typ C (Rinse Aid, Batch number: KSC.241-788 11.04.2022 wfk) is referred to as IEC-C and was used as Rinse aid.

### Test Procedure:

Glasses, plates and knives were placed in a dishwashing machine and treated with Neodisher and citric acid and two cycles with the test detergent.

The dishwashing machine has been modified in a way that the commercial ion exchanger has been put out of operation. The machine was provided with defined water via an external tank.

The rinse aid dispenser was empty. In case of test usage of rinse aid, it was inserted by hand with a pipette.

In the beginning of cleaning cycle, 50 g of ballast soil were added. After the program was finished, the front door was kept close for additional 10 minutes. Then the door was fully opened and the dishwasher racks were completely pulled out of the machine.

The evaluation was started after 20 minutes. After the crockery was completely dried, the rinse aid effect was evaluated visually in a “black box” under defined light conditions. Any dried drops, streaks, deposit or dull film on the crockery and cutlery was assessed. Three repetitions (cumulative) of each product were tested and the arithmetical mean was calculated.

### Results:

### 1. Visual Evaluation Water and Salt Spots

Glass Arcoroc Plates and Porcelain Schonwald Plates were treated as described above under test conditions and test procedure.

Briefly described, the plates were placed in a dishwasher together with ballast soil, and either (i) detergent (IEC-D) and rinse aid (IEC-C) or (ii) detergent (IEC-D) and rinse aid (IEC-C) combined with silkgel were added.

Three repetitions (cumulative) of the washing cycle for each product were performed followed by visual grading for salt and water spots. In addition, the arithmetical mean was calculated.

The visual grading for Spots was carried out by an independent institute (Fresenius Institute) according to an 8-point scale for water and salt spots, where:
8=free of spots and stripes,
7=few very slight stripes and/or few very small spots,
6=few slight stripes and/or some small spots,
5=slight or medium stripes and/or few medium sized spots,
4=few medium stripes and/or medium sized spots,
3=medium stripes and/or few large spots,
2=few large stripes and/or large spots, and
1=large stripes and/or numerous large spots and 0=very large stripes and/or very numerous large spots.

The arithmetical mean for glass Arcoroc plates washed with IEC-D+IEC-C was calculated as 7.0, while the arithmetical mean after the addition of IEC-D+IEC-C+Silkgel was 7.2. The arithmetical mean for Porcelain Schonwald Plates washed with IEC-D+IEC-C was calculated as 7.0, while the arithmetical mean after the addition of IEC-D+IEC-C+Silkgel was 7.3.

In summary, it was observed that the number of spots was reduced when washing Glass Arcoroc Plates and Porcelain Schonwald Plates, with IEC-D+IEC-C+Silkgel, compared to washing with only IEC-D+IEC-C (Table 1).

| | Plates Glass | Plates Porcelain |
|---|---|---|
| | Arcoroc | Schönwald |
| IEC-D + IEC-C + Silkgel | 7.2 | 7.3 |
| IEC-D + IEC-C | 7.0 | 7.0 |

Table 1: shows the results of a Comparative rinse aid test of Automatic Dishwashing Detergents in accordance with Fresenius Standard Method 03_2016. The Detergents IEC 60436—Typ D, here referred to as IEC-D and the rinse aid IEC 60436—Typ C, here referred to as IEC-C, were tested with and without Silkgel. The combinations are compared towards reduction of spot formation on plates, after three repeated cycles of washing in a washing machine according to Fresenius Standard Method 03_2016 SOP M 2422 Version 2.

### 2. Digital Image Analysis

The tested drinking glasses were evaluated visual and subsequently measured by digital image analyse. For this each glass was fixed on a rack and illuminated with a special source of light. During the digital measuring, the glass turned an angle of 360°. A plane picture is the result. By special software the number of spots, the size and the intensity could be calculated. The bottom and the top of the glass were ignored.

The Classification of the results was carried out using the following grading:
5=very big spots,
4=big spots,
3=medium sized spots,
2=small spots, and
1=very small spots.

When glassware was treated with detergent and rinse aid (IEC-D+IEC-C)—silkgel, medium sized spots were detected on the glass surface after the three consecutive washing rounds. For the glassware washed with detergent and rinse aid (IEC-D+IEC-C)+silkgel, only small sized spots were detected on the glass surface after the three consecutive washing rounds. The evaluation of spot formation was 3 for the glass samples treated with detergent and rinse aid (IEC-D+IEC-C)—silkgel, and 2 for the glass samples treated with detergent and rinse aid (IEC-D+IEC-C)+silkgel.

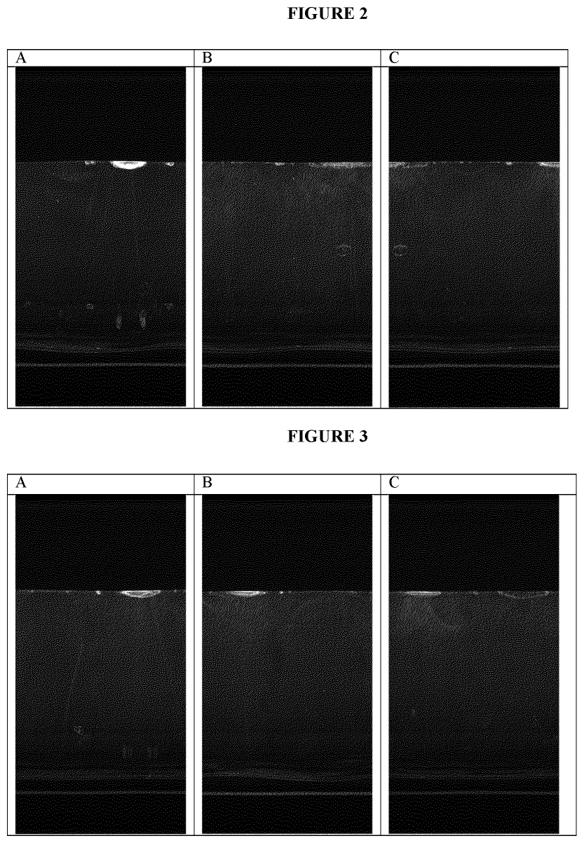

Therefore, the addition of silkgel to rinse aid and detergent leads to a reduction of spot formation on glass ware and provides an optical improvement (see FIGS. 2 and 3).

In the experiments described above, the use of the spider silk polypeptide C₁₆ is preferred.

### SEQUENCE LISTING

AA sequences for sequence listing
C^{X}-modules
SEQ ID NO: 1 (module C):
GSSAAAAAAAASGPGGYGPENQGPSGPGGYGPGGP
SEQ ID NO: 2 (module C^{Cys}):
GSSAAAAAAAASGPGGYGPENQGPCGPGGYGPGGP
SEQ ID NO: 3 (module C^{Lys}):
GSSAAAAAAAASGPGGYGPKNQGPSGPGGYGPGGP
TAGs and Linker
SEQ ID NO: 4 (T7-TAG)
MASMTGGQQMG
SEQ ID NO: 5 (Linker)
RGSM
C^{x}16-proteins
SEQ ID NO: 6 (C₁₆):
MASMTGGQQMGRGSMGSSAAAAAAAASGPGGYGPENQGPSGPGGYGPGGPGSS
AAAAAAAASGPGGYGPENQGPSGPGGYGPGGPGSSAAAAAAAASGPGGYGPEN
QGPSGPGGYGPGGPGSSAAAAAAAASGPGGYGPENQGPSGPGGYGPGGPGSSAA
AAAAAASGPGGYGPENQGPSGPGGYGPGGPGSSAAAAAAAASGPGGYGPENQGP
SGPGGYGPGGPGSSAAAAAAAASGPGGYGPENQGPSGPGGYGPGGPGSSAAAAA
AAASGPGGYGPENQGPSGPGGYGPGGPGSSAAAAAAAASGPGGYGPENQGPSGP
GGYGPGGPGSSAAAAAAAASGPGGYGPENQGPSGPGGYGPGGPGSSAAAAAAAA
SGPGGYGPENQGPSGPGGYGPGGPGSSAAAAAAAASGPGGYGPENQGPSGPGGY
GPGGPGSSAAAAAAAASGPGGYGPENQGPSGPGGYGPGGPGSSAAAAAAAASGP
GGYGPENQGPSGPGGYGPGGPGSSAAAAAAAASGPGGYGPENQGPSGPGGYGPG
GPGSSAAAAAAAASGPGGYGPENQGPSGPGGYGPGGPG
SEQ ID NO: 7 (C^{Lys}₁₆):
MASMTGGQQMGRGSMGSSAAAAAAAASGPGGYGPKNQGPSGPGGYGPGGPGSS
AAAAAAAASGPGGYGPKNQGPSGPGGYGPGGPGSSAAAAAAAASGPGGYGPKN
QGPSGPGGYGPGGPGSSAAAAAAAASGPGGYGPKNQGPSGPGGYGPGGPGSSAA
AAAAAASGPGGYGPKNQGPSGPGGYGPGGPGSSAAAAAAAASGPGGYGPKNQG
PSGPGGYGPGGPGSSAAAAAAAASGPGGYGPKNQGPSGPGGYGPGGPGSSAAAA
AAAASGPGGYGPKNQGPSGPGGYGPGGPGSSAAAAAAAASGPGGYGPKNQGPSG
PGGYGPGGPGSSAAAAAAAASGPGGYGPKNQGPSGPGGYGPGGPGSSAAAAAAA
ASGPGGYGPKNQGPSGPGGYGPGGPGSSAAAAAAAASGPGGYGPKNQGPSGPGG
YGPGGPGSSAAAAAAAASGPGGYGPKNQGPSGPGGYGPGGPGSSAAAAAAAASG
PGGYGPKNQGPSGPGGYGPGGPGSSAAAAAAAASGPGGYGPKNQGPSGPGGYGP
GGPGSSAAAAAAAASGPGGYGPKNQGPSGPGGYGPGGPG
SEQ ID NO: 8 (C)₁₆C^{Cys}
MASMTGGQQMGRGSMGSSAAAAAAAASGPGGYGPENQGPSGPGGYGPGGPGSS
AAAAAAAASGPGGYGPENQGPSGPGGYGPGGPGSSAAAAAAAASGPGGYGPEN
QGPSGPGGYGPGGPGSSAAAAAAAASGPGGYGPENQGPSGPGGYGPGGPGSSAA
AAAAAASGPGGYGPENQGPSGPGGYGPGGPGSSAAAAAAAASGPGGYGPENQGP
SGPGGYGPGGPGSSAAAAAAAASGPGGYGPENQGPSGPGGYGPGGPGSSAAAAA
AAASGPGGYGPENQGPSGPGGYGPGGPGSSAAAAAAAASGPGGYGPENQGPSGP
GGYGPGGPGSSAAAAAAAASGPGGYGPENQGPSGPGGYGPGGPGSSAAAAAAAA
SGPGGYGPENQGPSGPGGYGPGGPGSSAAAAAAAASGPGGYGPENQGPSGPGGY
GPGGPGSSAAAAAAAASGPGGYGPENQGPSGPGGYGPGGPGSSAAAAAAAASGP
GGYGPENQGPSGPGGYGPGGPGSSAAAAAAAASGPGGYGPENQGPSGPGGYGPG
GPGSSAAAAAAAASGPGGYGPENQGPSGPGGYGPGGPGSSAAAAAAAASGPGGY
GPENQGPCGPGGYGPGGP
Larger C-proteins
SEQ ID NO: 9 C32
MASMTGGQQMGRGSMGSSAAAAAAAASGPGGYGPENQGPSGPGGYGPGGPGSS
AAAAAAAASGPGGYGPENQGPSGPGGYGPGGPGSSAAAAAAAASGPGGYGPEN
QGPSGPGGYGPGGPGSSAAAAAAAASGPGGYGPENQGPSGPGGYGPGGPGSSAA
AAAAAASGPGGYGPENQGPSGPGGYGPGGPGSSAAAAAAAASGPGGYGPENQGP
SGPGGYGPGGPGSSAAAAAAAASGPGGYGPENQGPSGPGGYGPGGPGSSAAAAA
AAASGPGGYGPENQGPSGPGGYGPGGPGSSAAAAAAAASGPGGYGPENQGPSGP
GGYGPGGPGSSAAAAAAAASGPGGYGPENQGPSGPGGYGPGGPGSSAAAAAAAA
SGPGGYGPENQGPSGPGGYGPGGPGSSAAAAAAAASGPGGYGPENQGPSGPGGY
GPGGPGSSAAAAAAAASGPGGYGPENQGPSGPGGYGPGGPGSSAAAAAAAASGP
GGYGPENQGPSGPGGYGPGGPGSSAAAAAAAASGPGGYGPENQGPSGPGGYGPG
GPGSSAAAAAAAASGPGGYGPENQGPSGPGGYGPGGPGSSAAAAAAAASGPGGY
GPENQGPSGPGGYGPGGPGSSAAAAAAAASGPGGYGPENQGPSGPGGYGPGGPG
SSAAAAAAAASGPGGYGPENQGPSGPGGYGPGGPGSSAAAAAAAASGPGGYGPE
NQGPSGPGGYGPGGPGSSAAAAAAAASGPGGYGPENQGPSGPGGYGPGGPGSSA
AAAAAAASGPGGYGPENQGPSGPGGYGPGGPGSSAAAAAAAASGPGGYGPENQ
GPSGPGGYGPGGPGSSAAAAAAAASGPGGYGPENQGPSGPGGYGPGGPGSSAAA
AAAAASGPGGYGPENQGPSGPGGYGPGGPGSSAAAAAAAASGPGGYGPENQGPS
GPGGYGPGGPGSSAAAAAAAASGPGGYGPENQGPSGPGGYGPGGPGSSAAAAAA
AASGPGGYGPENQGPSGPGGYGPGGPGSSAAAAAAAASGPGGYGPENQGPSGPG
GYGPGGPGSSAAAAAAAASGPGGYGPENQGPSGPGGYGPGGPGSSAAAAAAAAS
GPGGYGPENQGPSGPGGYGPGGPGSSAAAAAAAASGPGGYGPENQGPSGPGGYG
PGGPG
SEQ ID NO: 10 C48
MASMTGGQQMGRGSMGSSAAAAAAAASGPGGYGPENQGPSGPGGYGPGGPGSS
AAAAAAAASGPGGYGPENQGPSGPGGYGPGGPGSSAAAAAAAASGPGGYGPEN
QGPSGPGGYGPGGPGSSAAAAAAAASGPGGYGPENQGPSGPGGYGPGGPGSSAA
AAAAAASGPGGYGPENQGPSGPGGYGPGGPGSSAAAAAAAASGPGGYGPENQGP
SGPGGYGPGGPGSSAAAAAAAASGPGGYGPENQGPSGPGGYGPGGPGSSAAAAA
AAASGPGGYGPENQGPSGPGGYGPGGPGSSAAAAAAAASGPGGYGPENQGPSGP
GGYGPGGPGSSAAAAAAAASGPGGYGPENQGPSGPGGYGPGGPGSSAAAAAAAA
SGPGGYGPENQGPSGPGGYGPGGPGSSAAAAAAAASGPGGYGPENQGPSGPGGY
GPGGPGSSAAAAAAAASGPGGYGPENQGPSGPGGYGPGGPGSSAAAAAAAASGP
GGYGPENQGPSGPGGYGPGGPGSSAAAAAAAASGPGGYGPENQGPSGPGGYGPG
GPGSSAAAAAAAASGPGGYGPENQGPSGPGGYGPGGPGSSAAAAAAAASGPGGY
GPENQGPSGPGGYGPGGPGSSAAAAAAAASGPGGYGPENQGPSGPGGYGPGGPG
SSAAAAAAAASGPGGYGPENQGPSGPGGYGPGGPGSSAAAAAAAASGPGGYGPE
NQGPSGPGGYGPGGPGSSAAAAAAAASGPGGYGPENQGPSGPGGYGPGGPGSSA
AAAAAAASGPGGYGPENQGPSGPGGYGPGGPGSSAAAAAAAASGPGGYGPENQ
GPSGPGGYGPGGPGSSAAAAAAAASGPGGYGPENQGPSGPGGYGPGGPGSSAAA
AAAAASGPGGYGPENQGPSGPGGYGPGGPGSSAAAAAAAASGPGGYGPENQGPS
GPGGYGPGGPGSSAAAAAAAASGPGGYGPENQGPSGPGGYGPGGPGSSAAAAAA
AASGPGGYGPENQGPSGPGGYGPGGPGSSAAAAAAAASGPGGYGPENQGPSGPG
GYGPGGPGSSAAAAAAAASGPGGYGPENQGPSGPGGYGPGGPGSSAAAAAAAAS
GPGGYGPENQGPSGPGGYGPGGPGSSAAAAAAAASGPGGYGPENQGPSGPGGYG
PGGPGSSAAAAAAAASGPGGYGPENQGPSGPGGYGPGGPGSSAAAAAAAASGPG
GYGPENQGPSGPGGYGPGGPGSSAAAAAAAASGPGGYGPENQGPSGPGGYGPGG
PGSSAAAAAAAASGPGGYGPENQGPSGPGGYGPGGPGSSAAAAAAAASGPGGYG
PENQGPSGPGGYGPGGPGSSAAAAAAAASGPGGYGPENQGPSGPGGYGPGGPGSS
AAAAAAAASGPGGYGPENQGPSGPGGYGPGGPGSSAAAAAAAASGPGGYGPEN
QGPSGPGGYGPGGPGSSAAAAAAAASGPGGYGPENQGPSGPGGYGPGGPGSSAA
AAAAAASGPGGYGPENQGPSGPGGYGPGGPGSSAAAAAAAASGPGGYGPENQGP
SGPGGYGPGGPGSSAAAAAAAASGPGGYGPENQGPSGPGGYGPGGPGSSAAAAA
AAASGPGGYGPENQGPSGPGGYGPGGPGSSAAAAAAAASGPGGYGPENQGPSGP
GGYGPGGPGSSAAAAAAAASGPGGYGPENQGPSGPGGYGPGGPGSSAAAAAAAA
SGPGGYGPENQGPSGPGGYGPGGPG

1. A rinse aid composition, comprising:
a) a structural polypeptide, and
b) at least one nonionic surfactant.

2. The rinse aid composition according to claim 1, wherein the structural polypeptide a) is a silk polypeptide.

3. The rinse aid composition according to claim 2, wherein the silk polypeptide
comprises or consists of a single unit of amino acids, or
comprises or consists of at least two identical repetitive units.

4. The rinse aid composition according to claim 3, wherein the silk polypeptide is free of non-repetitive units.

5. The rinse aid composition according to claim 3, wherein the single unit or the repetitive units are independently selected from the group consisting of
module C having an amino acid sequence according to SEQ ID NO: 1 or variants thereof,
module C^{Cys} having an amino acid sequence according to SEQ ID NO: 2 or variants thereof,
module C^{Lys} having an amino acid sequence according to SEQ ID NO: 3 or variants thereof.

6. The rinse aid composition according to claim 5, wherein the silk polypeptide is selected from the group consisting of (C)ₘ, (C)ₘC^{Cys}, (C)ₘC^{Lys}, C^{Cys}(C)ₘ, C^{Lys}(C)ₘ, (C^{Cys})ₘ and (C^{Lys})ₘ, wherein m is an integer of 1 to 96.

7. The rinse aid composition according to claim 6, wherein the silk polypeptide is selected from the group consisting of C₁, C₂, C₃, C₄, C₅, C₆, C₇, C₈, C₁₆, C₃₂, C₄₈, (C)₁C^{Cys}, (C)₂C^{Cys}, (C)₃C^{Cys}, (C)₄C^{Cys}, (C)₅C^{Cys}, (C)₆C^{Cys}, (C)₇C^{Cys}, (C)₈C^{Cys}, (C)₁₆C^{Cys}, (C)₃₂C^{Cys}, (C)₄₈C^{Cys}, (C)₁C^{Lys}, (C)₂C^{Lys}, (C)₃C^{Lys} (C)₄C^{Lys}, (C)₅C^{Lys}, (C)₆C^{Lys}, (C)₇C^{Lys} (C)₈C^{Lys}, (C)₁₆C^{Lys}, (C)₃₂C^{Lys}, (C)₄₈C^{Lys} C^{Cys}(C)₁, C^{Cys}(C)₂, C^{Cys}(C)₃, C^{Cys}(C)₄, C^{Cys}(C)₅, C^{Cys}(C)₆, C^{Cys}(C)₇, C^{Cys}(C)₈, C^{Cys}(C)₁₆, C^{Cys}(C)₃₂, C^{Cys}(C)₄₈, C^{Lys}(C)₁, C^{Lys}(C)₂, C^{Lys}(C)₃, C^{Lys}(C)₄, C^{Lys}(C)₅, C^{Lys}(C)₆, C^{Lys}(C)₇, C^{Lys}(C)₈, C^{Lys}(C)₁₆, C^{Lys}(C)₃₂, C^{Lys}(C)₄₈, C^{Cys}₁, C^{Cys}₂, C^{Cys}₃, C^{Cys}₄, C^{Cys}₅, C^{Cys}₆, C^{Cys}₇, C^{Cys}₈, C^{Cys}₁₆, C^{Cys}₃₂, C^{Cys}₄₈, C^{Lys}₁, C^{Lys}₂, C^{Lys}₃, C^{Lys}₄, C^{Lys}₅, C^{Lys}₆, C^{Lys}₇, C^{Lys}₈, C^{Lys}₁₆, C^{Lys}₃₂ and C^{Lys}₄₈.

8. The rinse aid composition according to claim 1, comprising from 0.0005 to 2.5% by weight, by weight based on the total weight of the composition, of at least one structural polypeptide (component a)).

9. The rinse aid composition according to claim 1, comprising from 0.5 to 89.9995% by weight, based on the total weight of the composition, of at least one nonionic surfactant (component b)).

10. The rinse aid composition according to claim 1, comprising from 10 to 95% by weight, based on the total weight of the composition, water (component c)).

11. The rinse aid composition according to claim 1, comprising at least one additional component, selected from functional additives (component d)), organic solvents and mixtures thereof, wherein the at least one functional additive d), is selected from surfactants different from component b), builders, hydrotropes, defoamers, pH controlling agents, further additives and mixtures thereof.

12. The rinse aid composition according to claim 11, comprising at least one further additive, selected from bleaches, enzymes, optical brighteners, antiredeposition agents, antimicrobial agents, antioxidants, rheology modifiers, solubility modifiers, stabilizing agents, corrosion inhibitors, dyes, fragrances, humectants, electrolytes, water conditioning agents and mixtures thereof.

13. The rinse aid composition according to claim 1, comprising:
a) at least one structural polypeptide,
b) at least one nonionic surfactant,
c) water,
d1) at least one builder,
d2) optionally at least one hydrotrope.

14. The rinse aid composition according to claim 1, wherein the rinse aid composition is present in form of a gel.

15. A method for machine cleaning of dishware, in which the dishware to be cleaned is contacted with a rinse aid composition as defined in claim 1.

16. A method for
providing good sheeting and wetting properties to dishware
reducing spotting and filming of dishware,
imparting dishware with a good shine,
preventing resoiling of dishware,
imparting dishware with a surface protection,
reducing the surface tension of dishware, or
improving the drying of dishware,
in which the dishware to be cleaned is contacted with a rinse aid composition as defined in claim 1.

17. The method of claim 13, wherein the at least one builder is selected from the group consisting of
citric acid and citric acid salts,
sulfonated copolymers and the salts thereof, and
mixtures thereof.

18. The rinse aid composition according to claim 2, wherein the silk polypeptide is a spider silk polypeptide.

19. The rinse aid composition according to claim 1, wherein the structural polypeptide is in the form of a gel.

20. The rinse aid composition according to claim 19, wherein the gel is a hydrogel.


SEQUENCE LISTING (10 sequences)

SEQ ID NO: 1 - protein, 35 aa, synthetic construct
GSSAAAAAAAASGPGGYGPENQGPSGPGGYGPGGP

SEQ ID NO: 2 - protein, 35 aa, synthetic construct
GSSAAAAAAAASGPGGYGPENQGPCGPGGYGPGGP

SEQ ID NO: 3 - protein, 35 aa, synthetic construct
GSSAAAAAAAASGPGGYGPKNQGPSGPGGYGPGGP

SEQ ID NO: 4 - protein, 11 aa, synthetic construct
MASMTGGQQMG

SEQ ID NO: 5 - protein, 4 aa, synthetic construct
RGSM

SEQ ID NO: 6 - protein, 576 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 7 - protein, 576 aa, synthetic construct
MASMTGGQQMGRGSMGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPGSSAAAAAAAASGPGGYGPKNQGPSGPGGYGPGGPG

SEQ ID NO: 8 - protein, 610 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPCGPGGYGPGGP

SEQ ID NO: 9 - protein, 1136 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG

SEQ ID NO: 10 - protein, 1696 aa, synthetic construct
MASMTGGQQMGRGSMGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPGSSAAAAAAAASGPGGYGPENQGPSGPGGYGPGGPG